(19) United States
(12) Patent Application Publication
(10) Pub. No.: US 2006/0009251 A1
(43) Pub. Date: Jan. 12, 2006

(54) RF device on insulating substrate and method of manufacturing RF device

(75) Inventors: Shunji Noda, Minato-ku (JP); Hiroshi Kanoh, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/176,233

(22) Filed: Jul. 8, 2005

(30) Foreign Application Priority Data
Jul. 9, 2004 (JP) 2004-203047

(51) Int. Cl. H04M 1/00

(52) U.S. Cl. 455/550.1

(57) ABSTRACT

An RF device which has excellent durability and communication capability, and which can be manufactured at a low cost, and a method of manufacturing such an RF device are disclosed. The RF device has an insulating substrate for blocking radio waves and preventing noise from being produced. The RF device also has a signal processing circuit formed on the insulating substrate so that it does not need junctions which would be formed by a mounting process. An antenna is integrally formed with the signal processing circuit on the insulating substrate, and is connected to the signal processing circuit.

### BACKGROUND OF THE INVENTION

1. Field of the Invention

The present invention relates to an RF device having an antenna and a signal processing circuit, for handling tag information, sensor information, security information, etc., a method of manufacturing such an RF device, a method of inspecting such an RF device, an RF apparatus, and a method of manufacturing such an RF apparatus.

2. Description of the Related Art

Recently, RF (Radio-Frequency) devices such as RF tags or noncontact IC cards are quickly being put to practical use. RF tags comprise an antenna, a memory, and a signal processing circuit, and tag information stored in the memory is transmitted to and from a dedicated reader/writer for merchandise management and security control.

As shown in FIG. 1 of the accompanying drawings, an RF tag has antenna 302 mounted on substrate 301 and IC chip 303 mounted on substrate 301 in electrical connection to antenna 302. Substrate 301 is usually made of inexpensive insulating plastics such as PET (Poly-Ethylene Terephthalate) or the like. Antenna 302 is made of a material having a relatively small electric resistance such as aluminum or the like, and is patterned substrate 301 by printing. IC chip 303 is thermally compressed to antenna 302 by ACF (Anisotropic Conductive Film) or the like.

In the RF tag shown in FIG. 1, IC chip 303 is directly mounted on substrate 301 with antenna 302 disposed thereon. Another RF tag has an IC chip mounted on a substrate (referred to as “inlet”) that is mounted on another substrate with an antenna disposed thereon. The IC chip is thermally compressed to interconnections on the inlet by ACF. The inlet is joined to the substrate by thermal compression or crimping, thereby connecting the interconnections on the inlet to the antenna.

The operating principles of a conventional RF tag will be described below.

As shown in FIG. 2 of the accompanying drawings, reader/writer 311 has controller 312, transmitter/receiver 313, and antenna 314. A signal generated by controller 312 is sent to transmitter/receiver 313, which sends the signal as a radio wave from antenna 314. RF tag 315 has antenna 316 and IC chip 317 which includes transmitter/receiver 318 and memory 319. Antenna 316 of RF tag 315 detects the radio wave transmitted from antenna 314 of reader/writer 311, and sends signal information of the detected radio wave to transmitter/receiver 318 of IC chip 317 to read information from and write information in memory 319. A signal read from memory 319 is sent to transmitter/receiver 318, which sends the signal as a radio wave from antenna 316 back to reader/writer 311. Reader/writer 311 sends the returned information to a computer (not shown). The computer uses the information for merchandise management and security control. The RF tag usually does not have a battery, and obtains necessary electromotive forces from the radio wave that is received by antenna 316.

A noncontact IC card operates according to operating principles which are essentially the same as the operating principles of the RF tag. However, RF tags and noncontact IC cards are used in different categories. Specifically, RF tags are used as tags on merchandise, and noncontact IC cards are used as authentication tools for ID cards and cash mediums for prepaid IC cards, for example.

As shown in FIG. 3 of the accompanying drawings, IC card 321 comprises device 322 and auxiliary member 324 that are sandwiched between two substrates 323 bonded together for making IC card 321 portable. Auxiliary member 324 has a central opening with device 322 accommodated therein. Device 322 comprises an IC chip mounted on a thin PET film with an antenna disposed on its surface. Device 322 alone is too low in mechanical strength to be used as a card. Therefore, two substrates 322 each made of a plastics material such as polycarbonate or ABS (Acrylonitrile-Butadiene-Styrene copolymer) are bonded to device 322 to make IC card 321 as thick as about 1 mm, thereby protecting device 322. When IC card 321 is carried by the user, device 322 is prevented from being damaged. Such an IC card is disclosed in JP-2002-279383-A and JP-2000-251037-A, for example.

Device 322 has a convex region where the IC chip is mounted, due to the thickness of the IC chip. If device 322 is simply sandwiched between substrates 323, then they would not be sufficiently joined together. Consequently, auxiliary member 324 is added as a spacer to provide flat surfaces to IC card 321. The surfaces of IC card 321 can thus be printed with clear patterns for increasing the commercial value thereof. Auxiliary member 324 is also able to increase the mechanical strength of IC card 321.

Another form of RF tag comprise a circuit including a transmitter/receiver, a memory, etc., and an antenna which are integrally incorporated in a single IC chip. For example, there is known an RF tag (ME-Y1002 manufactured by Hitachi Maxell) having a signal processing circuit, a memory, and an antenna that are mounted on a square silicon chip having sides each 2.5 mm long. In the RF tag, the signal processing circuit and the memory are fabricated according to the ordinary CMOS (Complementary Metal Oxide Semiconductor) silicon process. After the signal processing circuit and the memory are produced, the antenna is formed on the silicon chip by copper plating. The antenna is of a spiral shape having a pitch that is slightly larger than 10 μm and extends to outermost peripheral edges of the silicon chip. Since the antenna is placed on the small silicon chip, the RF tag has a short communication range of 2.5 mm or less.

JP-H08-77317-A and JP-H10-162112-A, for example, disclose a technology for integrally forming a small antenna and a signal processing circuit on a silicon chip. These publications indicate that an IC card can be reduced in size and the cost required for mounting the components on the silicon chip can be lowered.

As described above, RF devices such as RF tags or the like are classified into two types, i.e., a type wherein a circuit and an antenna are formed on separate substrates (hereinafter referred to as “separate type”) and a type wherein a circuit and an antenna are integrally formed on a substrate (hereinafter referred to as “integral type”). A process of determining when to use an antenna based on required electromotive forces is revealed in, for example, PHILIPS “I-CODE Coil Design Guide”, September 2002, and Steve C. Q. Chen, et. al., “OPTIMIZATION OF INDUCTIVE RFID TECHNOLOGY”, 2001, IEEE, p. 82-87.

The conventional RF devices such as RF tags or the like suffer the following problems:

The separate-type RF device is problematic in that they are of low durability. Specifically, since the separate-type RF device is of such a structure that an IC chip mounted on a substrate with an antenna disposed thereon, junctions between these components are not highly reliable. If the terminal of the IC chip and the antenna arb connected to each other by ACF, then because the components are thermally expanded at different rates when the RF device is in a high-temperature environment and thermally contracted at different rates when the RF device is in a low-temperature environment, significant thermal stresses are developed in the components. For example, RF tags are attached to various products and placed in various different environments. They may be kept at low temperatures when placed in containers on airplanes or they may be kept at high temperatures when carried on pallets on factory production lines. Therefore, the RF tags are liable to undergo thermal stresses, which tend to break the junctions between the components thereof. The junctions between the components of RF tags can also be broken when products with the RF tags attached thereto are vibrated or shocked during shipment or when the RF tags are subjected to bending stresses while being applied to clothes or paper products. Actually, an introduction test conducted on conventional separate-type RF tags reported that they had a failure rate of nearly 10%.

Separate-type RF devices are highly costly to manufacture. Inasmuch as RF tags are expected to replace existing bar codes in the future, their manufacturing cost should desirably be reduced to several yen per RF tag. IC chips for use in RF devices are fabricated according to the so-called semiconductor process, a certain reduction in the cost of the IC chips can be expected by reducing the chip size and shortening the fabrication process, as is the case with the cost of DRAMs. However, smaller-size IC chips are likely to suffer an increase in the cost of mounting them. For example, for mounting a square IC chip having sides each of 0.3 mm (μ chip manufactured by Hitachi, Ltd.) on an antenna, a production facility having a very high handling capability is needed. In view of the yield and other factors, it is a task that cannot easily be achieved to reduce the manufacturing cost of separate-type RF devices.

Another drawback of separate-type RF devices is that when they are incorporated in IC cards, they have a poor appearance. Attempts to improve the appearance tend to incur expenses. Specifically, as shown in FIG. 3, since an RF device has a convex region due to an IC chip, when the RF device is incorporated in an IC card, the IC card has surface irregularities, which are not only unpleasing to the eye, but also make it difficult to form high-resolution printed patterns thereon. In order to reduce the surface irregularities, the RF device needs to have an auxiliary member having a certain thickness. However, adding the auxiliary member increases the number of components of the RF device and the manufacturing cost thereof.

Integral-type RF tags are disadvantageous in that they have a low communication capability. RF tags have a large merit in that they can send and receive signals in a noncontact fashion, and are more convenient to use if their communication range is wider. However, conventional integral-type RF tags have a circuit and an antenna that are disposed on the surface of a silicon substrate, and since the silicon substrate is a conductor, radio waves emitted from the antenna are blocked by the silicon substrate. Therefore, radio waves cannot be sent and received through the surface on which the antenna is mounted. Another problem is that a current induced in the silicon substrate tends to increase noise and hence lower communication sensitivity.

Heretofore, because silicon substrates are expensive to manufacture, RF devices are designed such that as many RF devices as possible can be obtained from a single silicon wafer. It is thus necessary to reduce the area of the antenna of an integral-type RF tag in order to lower the cost thereof. For example, the RF tag referred to above (ME-Y1002 manufactured by Hitachi Maxell) has an antenna mounted on a square silicon chip having sides each 2.5 mm long. JP-H08-77317-A employs a small antenna on a silicon chip.

The communication capability of an antenna is largely affected by the size of the antenna. An antenna having a larger size has a higher sensitivity. If electromotive forces generated from radio waves received by an RF tag are used as electric power for energizing the RF tag, then increasing the size of the antenna of the RF tag is effective to increase magnetic fluxes passing through the antenna for thereby generating larger electromotive forces, which can increase the strength of radio waves radiated from the antenna. Consequently, the size of the antenna of an RF tag is a parameter that is most effective to increase the communication range of the RF tag. With IC chips having silicon substrates, however, the antenna size cannot be increased due to the cost limitation. As described above, the RF tag referred to above (ME-Y1002 manufactured by Hitachi Maxell) has a small chip size having sides each 2.5 mm long and has a short communication range of 2.5 mm or less. This communication range is much smaller than the communication range of separate-type RF tags which is several tens cm.

Separate-type RF devices have an antenna disposed on the surface of an inexpensive PET substrate. Therefore, it is not necessary to make serious attempts to reduce the size of the antennas of separate-type RF devices from the standpoint of cost. Instead, separate-type RF devices may be designed freely within the limitations posed by the outer profile of a card to be employed, for example, so as to achieve a sufficient communication capability.

Specifically, the antenna of a separate-type RF device may be formed within a rectangular area having a longitudinal length of 7 cm and a transverse length of 5 cm.

### SUMMARY OF THE INVENTION

It is an object of the present invention to provide an RF device which has excellent durability, communication capability, and appearance and which can be manufactured at a low cost, a method of manufacturing such an RF device, a method of inspecting such an RF device, an RF apparatus, and a method of manufacturing such an RF apparatus.

To achieve the above object, an RF device according to the present invention has an insulating substrate, a signal processing circuit, and an antenna for radio communications. The signal processing circuit is disposed on the insulating substrate. The antenna for radio communications is integrally formed with the signal processing circuit on the insulating substrate, and is connected to the signal processing circuit.

An RF apparatus according to the present invention has a plurality of RF devices described above, the RF devices being stacked together.

In a method of manufacturing an RF device according to the present invention, a signal processing circuit is formed on an insulating substrate according to a TFT fabrication process, and an antenna connected to the signal processing circuit is formed on the insulating substrate.

In a method of manufacturing an RF apparatus according to the present invention, an RF device is fabricated by the method of manufacturing an RF device according to the present invention, and a plurality of the RF devices are stacked and secured together.

In a method of inspecting an RF device according to the present invention, a conductive plate made of a conductive material and having an opening for alignment with a single RF device or a plurality of spaced RF devices is positionally adjusted with respect to an RF device sheet having a plurality of RF devices each comprising a signal processing circuit and an antenna disposed on an insulating substrate, to position the opening in alignment with the single RF device or the spaced RF devices. Then, the single RF device or the spaced RF devices are inspected by applying an inspecting signal by way of radio waves to the single RF device or the spaced RF devices.

According to the present invention, there is provided an apparatus for inspecting an RF device on an RF device sheet having a plurality of RF devices each comprising a signal processing circuit and an antenna disposed on an insulating substrate. The apparatus has a conductive plate and a reader/writer. The conductive plate is made of a conductive material and has an opening for alignment with a single RF device or a plurality of spaced RF devices. The opening is positioned in alignment with the single RF device or the RF devices to be inspected. The reader/writer applies an inspecting signal by way of radio waves to the single RF device or the spaced RF devices.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a perspective view of a conventional RF tag;

FIG. 2 is a block diagram of a conventional RF tag and reader/writer;

FIG. 3 is an exploded perspective view of a conventional noncontact IC card;

FIG. 4 is a perspective view of an RF device according to a first embodiment of the present invention;

FIG. 5 is a block diagram of a circuit arrangement of the RF device according to the first embodiment;

FIGS. 6A through 6D are graphs of coil wire widths represented by the horizontal axis and electromotive forces represented by the vertical axis, the graphs showing how the coil wire width affects the electromotive forces with respect to different numbers of coil turns and different coil profiles;

FIGS. 7A through 7C are graphs of coil wire widths represented by the horizontal axis and electromotive forces represented by the vertical axis, the graphs showing how the coil wire width affects the electromotive forces with respect to different numbers of coil turns and different coil profiles;

FIGS. 8A through 8C are fragmentary cross-sectional views showing successive steps of a method of manufacturing an RF device according to a second embodiment of the present invention;

FIG. 8D is a perspective view of the RF device that is manufactured by the method according to the second embodiment of the present invention;

FIGS. 9A through 9F are fragmentary cross-sectional views showing successive steps of a process of manufacturing a CMOS transistor of a signal processing circuit of the RF device according to the second embodiment of the present invention;

FIGS. 10A through 10C are fragmentary cross-sectional views showing successive steps of a process of manufacturing an antenna of the RF device according to the second embodiment of the present invention;

FIGS. 11A and 11B are fragmentary cross-sectional views showing successive steps of a process of manufacturing an antenna according to a first modification of the RF device according to the second embodiment of the present invention;

FIGS. 12A and 12B are fragmentary cross-sectional views showing successive steps of a process of manufacturing an antenna according to a second modification of the RF devise according to the second embodiment of the present invention;

FIG. 13 is a perspective view of an RF device according to a third embodiment of the present invention;

FIG. 14 is a perspective view of an RF device according to a fourth embodiment of the present invention;

FIG. 15 is a perspective view of an RF device according to a fifth embodiment of the present invention;

FIG. 16 is a perspective view of an RF device according to a sixth embodiment of the present invention;

FIG. 17 is a perspective view of an RF device according to a seventh embodiment of the present invention;

FIG. 18 is a perspective view of an RF device according to an eighth embodiment of the present invention;

FIG. 19 is a perspective view of an RF device according to a ninth embodiment of the present invention;

FIGS. 20A through 20D are cross-sectional views showing successive steps of a process of etching an insulating substrate of the RF device according to the ninth embodiment of the present invention;

FIG. 21 is an exploded perspective view of an RF apparatus according to a tenth embodiment of the present invention;

FIG. 22A is a schematic view showing a process of laminating components of an RF apparatus according to a comparative example;

FIG. 22B is a schematic view showing a process of laminating components of the RF apparatus according to the tenth embodiment;

FIG. 23 is a schematic view showing a process of manufacturing the RF apparatus according to the tenth embodiment;

FIG. 24 is a schematic view showing another process of manufacturing the RF apparatus according to the tenth embodiment;

FIGS. 25A and 25B are perspective views showing successive steps of a process of inspecting an RF device according to an eleventh embodiment of the present invention; and

FIG. 26 is a schematic view showing a modified process of inspecting the RF device according to the eleventh embodiment of the present invention.

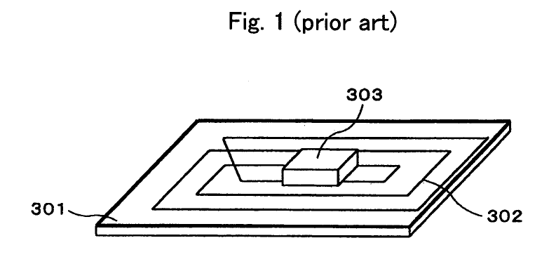

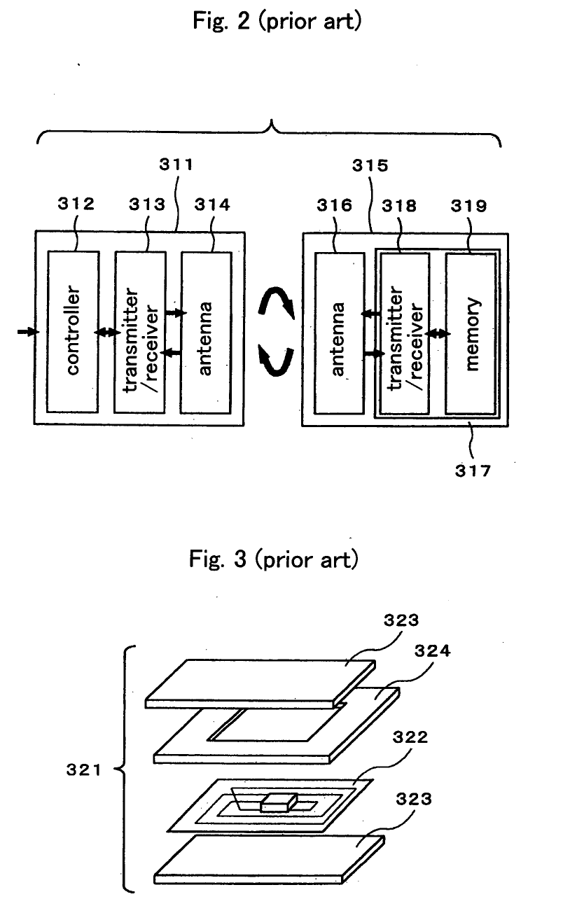

### DETAILED DESCRIPTION OF THE PREFERRED EMBODIMENTS

An RF device according to a first embodiment of the present invention will first be described below.

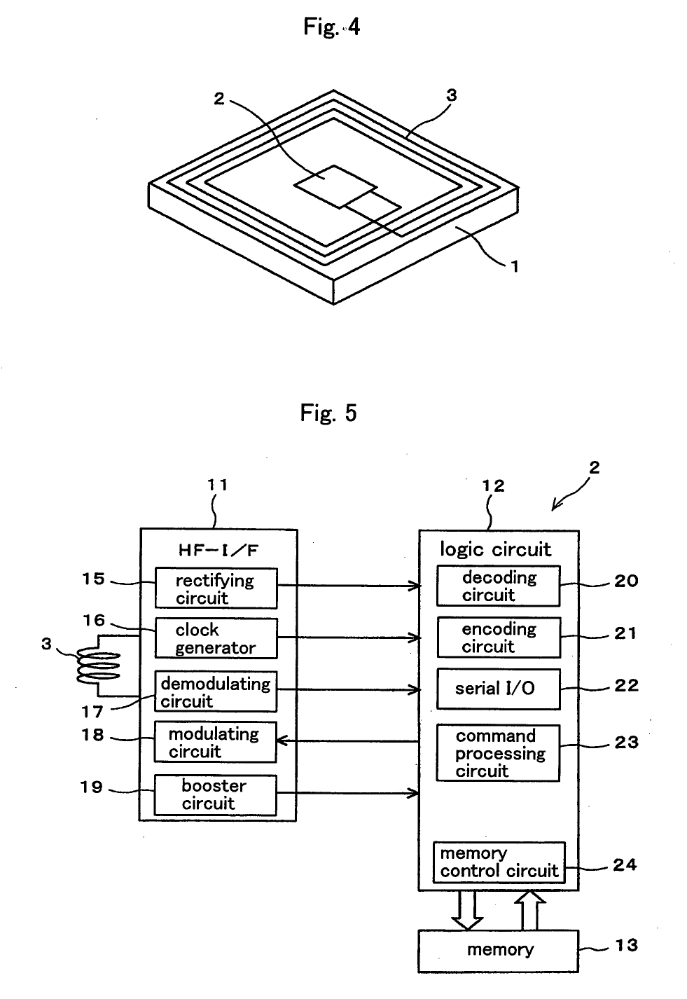

As shown in FIG. 4, the RF device according to the first embodiment of the present invention has insulating substrate 1 supporting rectangular signal processing circuit 2 and spiral antenna 3 that are integrally formed thereon. Insulating substrate 1 may comprise a glass substrate or a plastic substrate. In the illustrated embodiment, insulating substrate 1 comprises a glass substrate. Antenna 3 comprises a single wire wound in a rectangular spiral pattern. Generally, RF tag systems for use in a 13.56 Hz frequency band operate on the principle of electromagnetic induction for the RF tag to obtain electromotive forces from radio waves. Antenna 3 has opposite terminals connected to one side of rectangular signal processing circuit 2 that is disposed centrally on the surface of insulating substrate 1. Antenna 3 has an outermost pattern edge disposed along the outer profile edge of insulating substrate 1. Antenna 3 is made of Au, Cu, Al, Ni, Ag, solder, a conductive high-polymer material, or a laminated film of these materials, for example. Antenna 3 has an area of 1 cm² or more surrounded by the outermost pattern edge thereof.

A process of determining the area of antenna 3, i.e., the specifications of antenna 3, will be described below.

First, a process of calculating electromotive forces generated by an antenna from the antenna specifications will be described below. The calculating process may be of known nature, as disclosed in “I-CODE Coil Design Guide” or “OPTIMIZATION OF INDUCTIVE RFID TECHNOLOGY”, p. 82-87, which is referred to above. The process of calculating electromotive forces is generally performed through the following steps:
[1] The inductance of spiral (coil) antenna 3 is determined for resonance at the communication frequency.
[2] An antenna configuration for obtaining the above inductance is determined.
[3] Specifications of a reader/writer are determined, and mutual inductance thereof with antenna 3 is determined.
[4] Electromotive forces generated by the RF device are determined on the principles of electromagnetic induction.

Electromotive forces required to operate signal processing circuit 2 are of 2 V, for example, and antenna specifications are determined in order to obtain such electromotive forces.

[1] Determination of the Inductance of a Coil Antenna:

For determining the inductance of a coil antenna, the communication frequency F is set to 13.56 MHz, i.e., 1.356×10⁷ Hz. The capacitance Cₚₗ of the entire RF device is determined according to the following equation (1):
Cₚₗ=C_{c}+C_{con}+C_{ic} (1)
where C_{c} represents the capacitance of the coil antenna, C_{con} the capacitance of the junction, and C_{ic} the capacitance of the signal processing circuit. If C_{c} is set to 2.00×10⁻¹¹ F, C_{con} to 2.00×10⁻¹² F, and C_{ic} to 3.00×10⁻¹¹ F, then capacitance Cₚₗ of the entire RF device is calculated as 5.20×10⁻¹¹ F according to the equation (1).

The inductance of the coil antenna is set to cause a circuit which is a combination of signal processing circuit 2 and antenna 3 to resonate at the communication frequency. The inductance Lₒ of the coil antenna is determined according to the following equation (2):

$${L}_{O} = \frac{1}{{( 2 π F )}^{2} \cdot {C}_{pl}} \qquad ( 2 )$$

The inductance Lₒ of the coil antenna is determined as 2.65×10⁻⁶ H according to the equation (2). This value is used as a target inductance for determining antenna specifications.

[2] Determination of an Antenna Configuration:

Then, an antenna configuration for obtaining the target inductance Lₒ is determined. Based on antenna specifications, an inductance L_{cal} is determined, and antenna specifications are determined to equalize the inductance L_{cal} substantially to the target inductance Lₒ. The inductance L_{cal} is determined according to the following equations (3) through (7):

$$\begin{matrix}{L}_{cal} = \frac{{μ}_{0}}{π} ( {x}_{1} + {x}_{2} - {x}_{3} + {x}_{4} ) \cdot {N}_{c}^{p} & ( 3 ) \\ {x}_{1} = {a}_{avg} \cdot ln [ \frac{2 \cdot {a}_{avg} \cdot {b}_{avg}}{d \cdot ( {a}_{avg} + \sqrt{{a}_{avg}^{2} + {b}_{avg}^{2}} )} ] & ( 4 ) \\ {x}_{2} = {b}_{avg} \cdot ln [ \frac{2 \cdot {a}_{avg} \cdot {b}_{avg}}{d \cdot ( {b}_{avg} + \sqrt{{a}_{avg}^{2} + {b}_{avg}^{2}} )} ] & ( 5 ) \\ {x}_{3} = 2 \cdot ( {a}_{avg} + {b}_{avg} + \sqrt{{a}_{avg}^{2} + {b}_{avg}^{2}} ) & ( 6 ) \\ {x}_{4} = \frac{{a}_{avg} + {b}_{avg}}{4} & ( 7 )\end{matrix}$$

Antenna specifications at the time the target inductance Lₒ is obtained are shown as follows: The number of coil turns: N_{c}=5, the coil wire width: w=1.00×10⁻³ m, the space between coil wires: g=6.00×10⁻⁴ m, the coil wire thickness: t=3.00×10⁻⁵ m, the horizontal width of the outermost coil profile: a₀=7.60×10⁻² m, the vertical width of the outermost coil profile: b₀=4.50×10⁻² m, the turn EXP: p=1.75, the magnetic permeability: μ₀=1.2566×10⁻⁶ H/m, the average of horizontal widths of the outer coil profile: a_{avg}=a₀−N_{c}×(w+g)−g=6.86×10⁻² m, the average of vertical widths of the outer coil profile: b_{avg}=b₀−N_{c}×(w+g)−g=3.76×10⁻² m, and the equivalent radius: d=2×(t+w)/π=6.56×10⁻⁴ m. Putting these values into the equations (3) through (7), the inductance L_{cal} is determined as 2.69×10⁻⁶ H, which is substantially equal to the value 2.65×10⁻⁶ H of the target inductance Lₒ.

[3] Calculation of a Mutual Inductance:

The mutual inductance between the coil antenna with the reader/writer is determined according to the following equation (8):

$$M = \frac{{μ}_{0} \cdot {N}_{c} \cdot {N}_{r} \cdot {a}_{r}^{2} \cdot ( {a}_{avg} \cdot {b}_{avg} )}{2 \cdot {( {a}_{r}^{2} + {r}^{2} )}^{\frac{3}{2}}} \qquad ( 8 )$$

At this time, the specifications of the reader/writer are determined based on the product (SLRM900) described in the document “I-CODE Coil Design Guide” referred to above, as follows: The number of coil turns of the reader/writer: Nᵣ=1, the coil radius: aᵣ=0.18 m, the communication range: r=0.5 m, and the current: Iᵣ=0.28 A (50 Ω, 4V). Putting these values into the equation (8), the mutual inductance is determined as M=1.75×10⁻⁹H/m.

[4] The Calculation of Generated Electromotive Forces:

A process of calculating electromotive forces generated in the RF device will be described below. Antenna 3 is made of aluminum, for example. Antenna 3 has a coil resistivity: ρp=2.655×10⁻⁸ Ω·m. The coil resistance R_{SC} of antenna 3 is determined according to the following equation (9):

$${R}_{sc} = \frac{ρ \cdot {N}_{c} \cdot 2 ( {a}_{avg} + {b}_{avg} )}{t \cdot w} \qquad ( 9 )$$

The coil resistance R_{SC} is calculated as 9.40×10⁻¹ Ω. The Q of the coil is determined according to the following equation (10):

$${Q}_{sc} = \frac{2 π f \cdot {L}_{cal}}{{R}_{sc}} \qquad ( 10 )$$

According to the equation (10), the Q of the coil is calculated as 244. The parallel equivalent circuit resistance R_{pc} of the coil is determined according to the following equation (11):
R_{pc}=R_{sc}·(1+Q_{sc}²) (11)

According to the equation (11), the parallel equivalent circuit resistance R_{pc} of the coil is calculated as 5.59×10⁻⁴ Ω. The parallel equivalent circuit inductance L_{pc} of the coil is determined according to the following equation (12):

$${L}_{pc} = \frac{{L}_{sc} \cdot {Q}_{sc}^{2}}{1 + {Q}_{sc}^{2}} \qquad ( 12 )$$

According to the equation (12), the parallel equivalent circuit inductance L_{pc} of the coil is calculated as 2.69×10⁻⁶ H. If it is assumed that signal processing circuit 2 has an equivalent circuit resistance R_{ic}=2.50×10⁻⁴ Ω, then the parallel equivalent resistance Rₚₗ of the entire circuit is determined according to the following equation (13):

$${R}_{pl} = \frac{{R}_{ic} \cdot {R}_{pc}}{{R}_{ic} + {R}_{pc}} \qquad ( 13 )$$

According to the equation (13), the parallel equivalent resistance Rₚₗ of the entire circuit is calculated as 1.73×10⁻⁴ Ω. The resonant frequency Fᵣ is determined according to the following equation (14):

$${F}_{r} = \frac{1}{2 π \sqrt{{L}_{pc} \cdot {C}_{pl}}} \qquad ( 14 )$$

According to the equation (14), the resonant frequency Fᵣ is calculated as 1.346×10⁻⁷ Hz. Electromotive forces generated in the coil (antenna 3) of the RF device are calculated according to the following equation (15):

$$V = \frac{2 π f \cdot M \cdot {I}_{r}}{\sqrt{{( 1 - \frac{F}{{F}_{r}} )}^{2} + {( 2 π f \cdot \frac{{L}_{pc}}{{R}_{pl}} )}^{2}}} \qquad ( 15 )$$

According to the equation (15), the electromotive forces are calculated as 2.04 V. In this manner, the generated electromotive forces can be calculated on the basis of the antenna specifications.

The relationship between the outer profile and generated electromotive forces of the coil antenna will be reviewed according to the above calculating process.

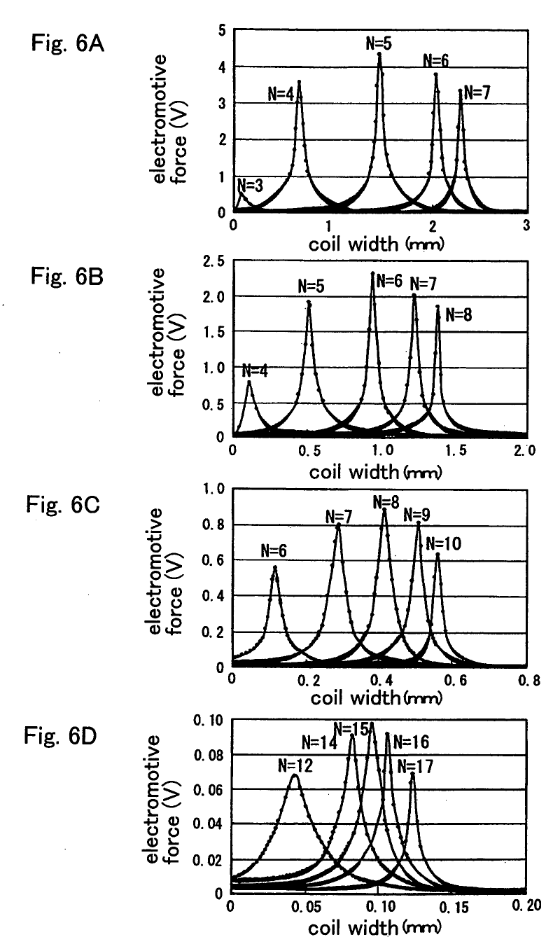

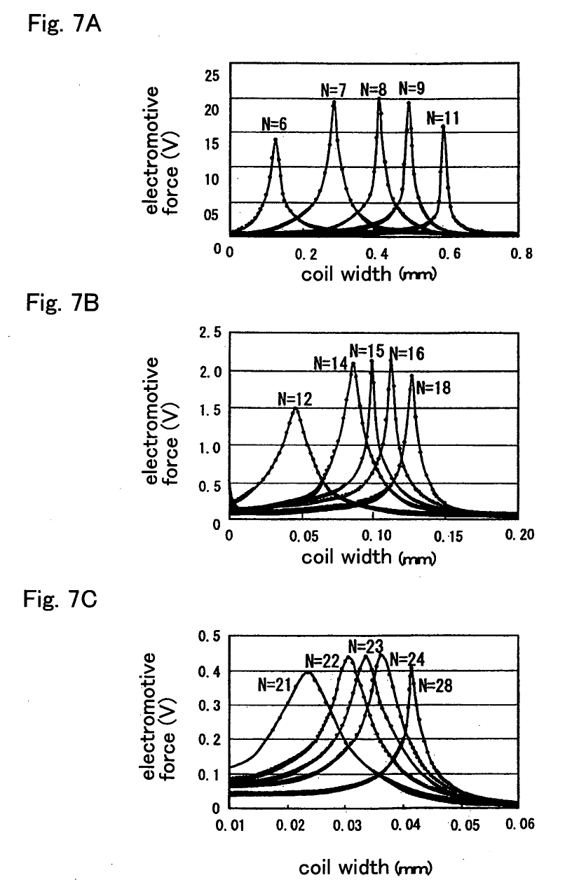

FIGS. 6A through 6D and 7A through 7C are graphs of coil wire widths represented by the horizontal axis and electromotive forces represented by the vertical axis, the graphs showing how the coil wire width affects the electromotive forces with respect to different numbers of coil turns and different coil profiles. In FIGS. 6A through 6D and 7A through 7C, N represents the number of coil turns. FIGS. 6A through 6D show data when the communication range of antenna 3 is 50 cm. FIG. 6A shows data when the coil profile is of a square shape having sides each 7 cm long. FIG. 6B shows data when the coil profile is of a square shape having sides each 5 cm long. FIG. 6C shows data when the coil profile is of a square shape having sides each 3 cm long. FIG. 6D shows data when the coil profile is of a square shape having sides each 2 cm long.

FIGS. 7A through 7C show data when the communication range of antenna 3 is 5 cm long. FIG. 7A shows data when the coil profile is of a square shape having sides each 3 cm long. FIG. 7B shows data when the coil profile is of a square shape having sides each 1 cm long. FIG. 7C shows data when the coil profile is of a square shape having sides each 0.5 cm long.

For the specifications and the circuit resistances and capacitances of the reader/writer, the above values used to calculate the electromotive forces are employed as general values. The thickness of the wire of the antenna is set to 30 μm. Each of FIGS. 6A through 6D and 7A through 7C shows data produced by the number of turns for generating maximum electromotive forces, ±2 turns.

As shown in FIGS. 6A through 6D and 7A through 7C, when the coil wire width is changed for each number of coil turns, the electromotive forces take a peak value at a certain coil wire width. This indicates that the coil impedance changes with the coil wire width, and the electromotive forces take a peak value at a coil wire width for best matching, i.e., at a coil wire width where the resonant frequency is equal to the communication frequency.

It is also seen from FIGS. 6A through 6D and 7A through 7C that the generated electromotive forces are maximum at a certain number of coil turns for each coil profile. The generated electromotive forces increase as the number of coil turns increases. However, since the coil profile is given, as the number of coil turns increases, the effective area (a_{avg}×b_{avg}) of the antenna decreases. As a result, the generated electromotive forces take a maximum value at a certain number of coil turns.

With the RF device according to the first embodiment, electromotive forces required to operate signal processing circuit 2 are of 2 V, for example. As shown in FIGS. 6A through 6D, if the communication range is 50 cm, the electromotive forces of 2 V are generated by the coil which has a square outer profile having sides each 3 cm or more long. Therefore, in order to achieve the communication range of 50 cm, the coil needs to have a square outer profile having sides each 3 cm or more long. As shown in FIGS. 7A through 7C, if the communication range is 5 cm long, the coil needs to have a square outer profile having sides each 1 cm or more long. Consequently, the RF device can have a communication range of 5 cm or more by providing an antenna area of 1 cm² or greater. The communication range should be 50 cm or longer in view of how RF tags are actually used. However, RF devices with a communication range of 5 cm or more can enjoy benefits of noncontact communication means. Therefore, the antenna profile should preferably be of a square shape having sides each 1 cm long, i.e., the antenna should preferably have an area of 1 cm² or greater.

As shown in FIG. 5, signal processing circuit 2 comprises high-frequency interface circuit 11, logic circuit 12, and memory 13. Antenna 3 is connected to high-frequency interface circuit 11.

High-frequency interface circuit 11 comprises rectifying circuit 15, clock generator 16, demodulating circuit 17, modulating circuit 18, and booster circuit 19. Rectifying circuit 15 rectifies a received radio wave and supplies a DC voltage to logic circuit 12. Clock generator 16 generates a clock signal required to operate logic circuit 12 based on a received radio wave. For example, clock generator 16 generates a clock signal having a frequency ranging from several tens to several hundreds kHz from a received frequency of several MHz. Demodulating circuit 17 demodulates data from the received radio wave (carrier wave). Modulating circuit 18 modulates a carrier wave with data to be transmitted. Booster circuit 19 increases an electromotive force that is generated by rectifying circuit 15 to a higher voltage. Booster circuit 19 needs to increase the electromotive force when a nonvolatile EEPROM (Electrically Erasable and Programmable Read Only Memory) or an FeRAM (Ferroelectric Random Access Memory) which requires a high operating voltage is used as memory 13.

Logic circuit 12 comprises decoding circuit 20, encoding circuit 21, serial I/O (Input/Output) 22, command processing circuit 23, and memory control circuit 24. Decoding circuit 20 decodes received data according to a PPM (Pulse Position Modulation) process or the like. Encoding circuit 21 encodes data to be transmitted according to the Manchester process. Serial I/O 22 converts a data string between serial and parallel formats. Command processing circuit 23 serves to control the flow of signals. Memory control circuit 24 writes received data into memory 13 and reads data to be transmitted from memory 13. Logic circuit 12 may also have a circuit for performing a parity check on data for the purpose of increasing the reliability of RF tags, and an anti-collision circuit for identifying a plurality of tags. Memory 13 comprises a ROM (Read Only Memory) or a nonvolatile write-once EEPROM or FeRAM depending on the purpose of RF tags. Alternatively, memory 13 may comprise a volatile memory such as a DRAM (Dynamic Random Access Memory) or an SRAM (Static Random Access Memory).

Operation and advantages of the RF device according to the first embodiment of the present invention will be described below.

As shown in FIGS. 4 and 5, the RF device according to the first embodiment has signal processing circuit 2 including high-frequency interface circuit 11, logic circuit 12, and memory 13, and antenna 3. Signal processing circuit 2 and antenna 3 are integrally mounted on insulating substrate 1. Since no process is required for mounting a chip including a signal processing circuit on a substrate with an antenna formed thereon, the manufacturing cost of the RF device is relatively low. The RF device is highly durable because it does not have junctions which would be formed by the mounting process that are vulnerable to thermal stresses, bending stresses, vibrations, shocks, etc. Since the antenna is disposed on the insulating substrate, radio waves are not electromagnetically shielded by the substrate, allowing the RF device to have an excellent communication capability. The RF device produces low noise because no induced current flows through the substrate. However, an RF device disposed on a silicon substrate is unable to obtain the same communication quality as when a glass substrate is used because the silicon substrate is a conductor and hence shields radio waves and noise is produced due to an eddy current generated in the silicon substrate. The RF device where the signal processing circuit and the antenna are integrally formed needs to have an insulating substrate such as a glass substrate or the like in order to provide a sufficient communication range.

Inasmuch as the RF device incorporates an inexpensive insulating substrate such as a glass substrate or the like, it can be manufactured at a lower cost than if it employs an expensive insulating substrate such as a silicon substrate or the like. The area of the antenna of the RF device according to the present invention can easily be increased for better communication ability. Specifically, conventional RF devices on silicon substrates are not practical because their square size having sides each 1 cm long makes the substrate highly costly. If a silicon wafer having a diameter of 3 inches is used to produce RF device substrates, then only slightly less than 300 RF devices can be produced from that silicon wafer. Conversely, if a plurality of RF devices are to be fabricated from a square glass substrate having sides each 1 m long, then 10000 RF devices each having a square size having sides each 1 cm long can simultaneously be produced from that glass substrate. Inasmuch as the cost of the glass substrate and the cost of each RF device produced from the glass substrate and the cost of the fabrication process are much lower than if RF devices are formed on a silicon wafer, the fabrication of RF devices having a square size having sides each 1 cm long on the glass substrate is practical.

As no IC chips are mounted on the surface of the RF device, the surface of the RF device does not have surface irregularities which would be formed by IC chips, and can be printed highly at high resolution. No auxiliary member is required to make the surface of the RF device flat, so that the number of parts of the RF device is relatively small and the cost of the RF device is relatively low.

In the first embodiment, antenna 3 comprises a coil antenna having a spiral structure. However, antenna 3 may comprise an antenna having another structure, such as a dipole antenna, a patch antenna, etc. If radio waves that are used for communications are microwaves in the 900 MHz band or 2.45 GHz band, then antenna 3 comprises a dipole antenna having a length equal to ½ or ¼ wavelength. The antenna length that is required is 16.7 cm if it is ½ wavelength of the 900 MHz band, and 8.3 cm if it is ¼ wavelength of the 900 MHz band. The antenna length that is required is 6.1 cm if it is ½ wavelength of the 2.45 GHz band, and 3.1 cm if it is ¼ wavelength of the 2.45 GHz band. Therefore, if a dipole antenna is used, then the antenna length should desirably be more than 3 cm. That is, the antenna of the RF device according to the present embodiment should preferably have a square outer profile having sides each 1 cm or more long and a length of 3 cm or more. The length of 3 cm is a large value for a chip size and is not practical for a device on a silicon substrate.

A second embodiment of the present invention will be described below. The second embodiment is concerned with a method of manufacturing the RF device according to the first embodiment described above.

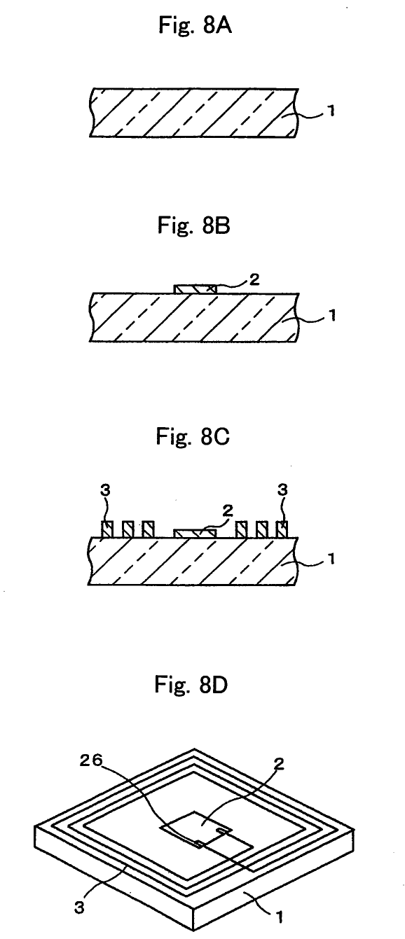

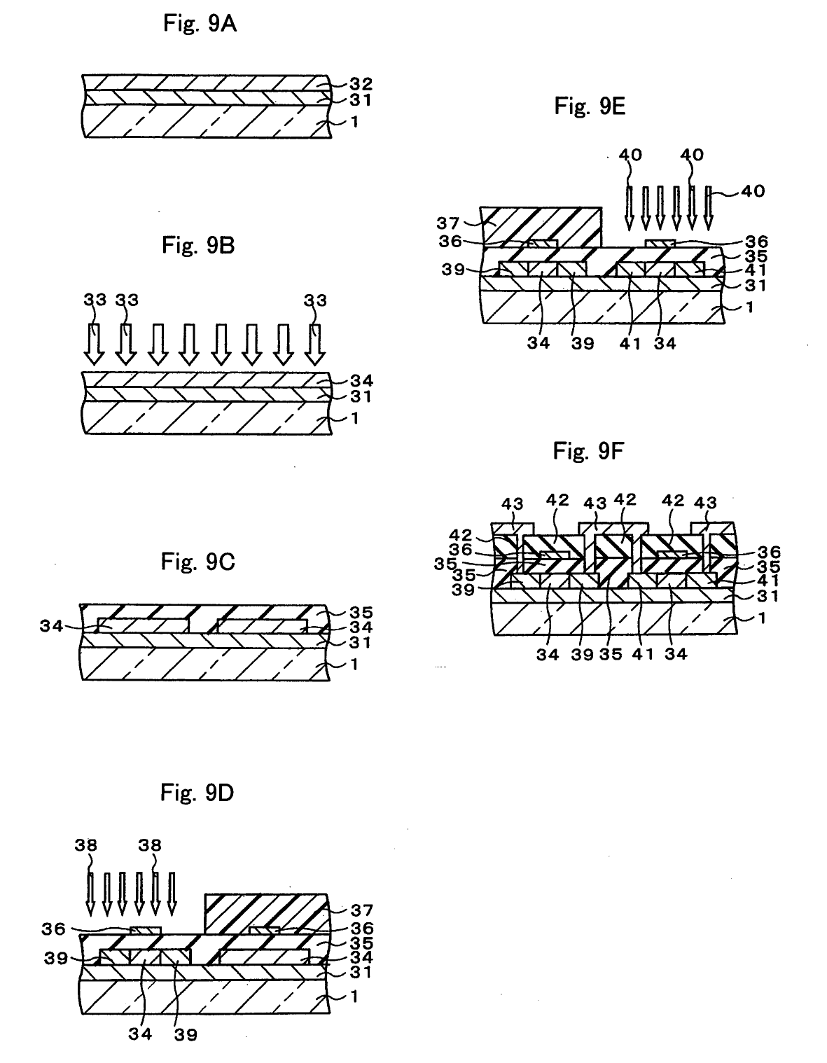

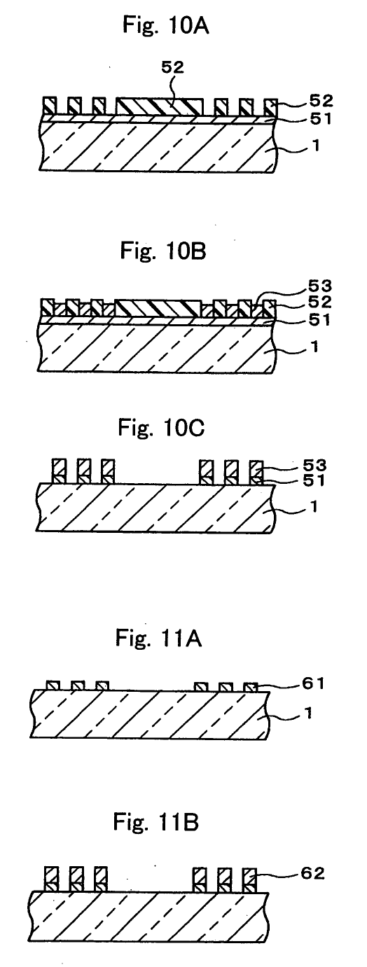

FIGS. 8A through 8C show successive steps of a method of manufacturing an RF device. FIG. 8C shows the RF device which is manufactured. FIGS. 9A through 9F show details of the step shown in FIG. 8B. FIGS. 10A through 10C show details of the step shown in FIG. 8C.

As shown in FIGS. 8A, 8B, and 8D, rectangular signal processing circuit 2 is formed centrally on insulating substrate 1 by the thin-film transistor (TFT) fabrication technology, and two terminals 26 are formed on and along one side of signal processing circuit 2. Insulating substrate 1 may comprise a glass substrate. In the method, a glass substrate for use in general liquid crystal displays is employed. Then, as shown in FIGS. 8C and 8D, spiral antenna 3 is formed of a conductive material on insulating substrate 1 by plating or printing. Antenna 3 comprises a single conductor formed in a rectangular spiral pattern and has opposite ends connected respectively to terminals 26 on signal processing circuit 2. Antenna 3 has an outermost turn extending along outer edges of insulating substrate 1.

A process of forming signal processing circuit 2 as shown in FIG. 8B will be described below. Signal processing circuit 2 is structurally based on a CMOS transistor formed by the TFT fabrication technology. In the present embodiment, a process of forming a CMOS-TFT on a glass substrate will be described below with reference to FIGS. 9A through 9F.

As shown in FIG. 9A, barrier film 31 is formed on insulating substrate 1 of glass by sputtering, for example, and then amorphous silicon film 32 is formed on the surface of barrier film 31. Amorphous silicon film 32 is deposited to a thickness ranging from 30 nm to 200 nm by CVD (Chemical Vapor Deposition) or sputtering. Then, as shown in FIG. 9B, a laser beam is applied to the assembly as indicated by the arrows 33 to anneal amorphous silicon film 32 into polycrystalline silicon film 34. The laser beam may be emitted from an excimer laser or a solid-state laser. Then, as shown in FIG. 9C, polycrystalline silicon film 34 on barrier film 31 is processed into two separate patterns by photolithography, after which gate insulating film 35 is formed over barrier film 31 and two polycrystalline silicon films 34. Gate insulating film 35 is deposited to a thickness ranging from 10 nm to 200 nm by CVD or sputtering.

Thereafter, as shown in FIG. 9D, two gate electrodes 36 are formed on gate insulating film 35 in respective regions including regions directly above respective two polycrystalline silicon films 34. Then, photoresist 37 is formed in a region where an n-channel TFT is to be formed, i.e., in the region including the region directly above one of two polycrystalline silicon films 34 in covering relation to one of gate electrodes 36 and gate insulating film 35. Then, boron is injected from above as indicated by the arrows 38 into a region where a p-channel TFT is to be formed, forming p-type regions 39 in opposite end portions of other polycrystalline silicon film 34. Boron is injected by ion doping, for example. Because of photoresist 37 functioning as a mask, no boron is injected into the region where the n-channel TFT is to be formed. Similarly, no boron is injected into the central portion of other polycrystalline silicon film 34 because gate electrode 36 functions as a mask in the region where the p-channel TFT is to be formed. After boron is injected, photoresist 37 is removed.

Then, as shown in FIG. 9E, photoresist 37 is formed in the region where the p-channel TFT is to be formed, i.e., in the region including the region directly above polycrystalline silicon film 34 including the p-type regions 39 in covering relation to gate electrode 36 and gate insulating film 35. Thereafter, phosphorus is injected from above as indicated by the arrows 40 into the region where the n-channel TFT is to be formed, forming n-type regions 41 in opposite end portions of polycrystalline silicon film 34. Phosphorus is injected by ion doping, for example. Because of photoresist 37 functioning as a mask, no phosphorus is injected into the region where the p-channel TFT is to be formed. Similarly, no phosphorus is injected into the central portion of polycrystalline silicon film 34 because gate electrode 36 functions as a mask in the region where the n-channel TFT is to be formed. After phosphorus is injected, photoresist 37 is removed.

Then, as shown in FIG. 9F, interlayer insulating films 42 and metal electrodes 43 are formed, thereby completing a CMOS circuit. Throughout the entire process of fabricating the CMOS circuit, the process temperature in the CVD or sputtering steps is set to 400° C. or lower, for example, in view of the heat resisting capability of the glass substrate.

A process of forming antenna 3 as shown in FIG. 8C will be described below with reference to FIGS. 10A through 10C. Antenna 3 is formed by electrolytic plating. As shown in FIG. 10A, conductive film 51 for use as an electrolytic plating feed layer is formed on insulating substrate 1. Then, as shown in FIG. 10B, photoresist 52 having an opening patterned as antenna 3 is formed on conductive film 51 by photolithography, and then plated film 53 is formed on conductive film 51 in the opening of photoresist 52 by electrolytic plating. Then, as shown in FIG. 10C, photoresist 52 is removed, and unwanted portions of conductive film 51 which are not covered with plated film 53 are etched away. Conductive film 51 and plated film 53 which make up antenna 3 are formed of gold or copper, for example.

A plurality of RF devices may simultaneously be fabricated on single insulating substrate 1. For simultaneously form a plurality of RF devices, a plurality of signal processing circuits 2 are formed on single insulating substrate 1, and then a plurality of antennas 3 are formed on single insulating substrate 1, thereby producing a plurality of sets of signal processing circuits 2 and antennas 3. Then, insulating substrate 1 is cut off into pieces including those sets of signal processing circuits 2 and antennas 3, whereupon a plurality of RF devices are simultaneously produced. A sheet-like substrate may be used as insulating substrate 1, and signal processing circuits 2 and antennas 3 may be formed on the sheet-like substrate as it is delivered from a roll to a roll.

Advantages offered by the second embodiment will be described below. In the method of manufacturing an RF device according to the second embodiment, signal processing circuit 2 and antenna 3 can integrally be formed on single insulating substrate 1 as shown in FIGS. 8A through 8D through FIGS. 10A through 10C. Since no device mounting steps are necessary, the RF device can be manufactured at a low cost. The RF device manufactured by the method according to the second embodiment is highly durable because it does not have junctions which would be formed by the mounting process that are vulnerable to thermal stresses, bending stresses, vibrations, shocks, etc. Since the signal processing circuit and the antenna are integrally formed on the inexpensive insulating substrate such as of glass, no mounting steps are required, and the RF device can be manufactured at a low cost. The antenna formed on the insulating substrate eliminates noise and antenna directivity, and can easily be produced in a large area for a better communication capability. According to the present embodiment, furthermore, since the antenna is fabricated by electrolytic plating, the antenna has a low resistance and causes a low loss of the received signal. Furthermore, the antenna can easily be formed in a desired shape. The antenna can be formed without causing damage to the signal processing circuit that has already been formed on the insulating substrate. The above advantages are available even if the antenna is formed by electroless plating, printing, conductive polymer patterning, or direct pattern writing.

In the method of manufacturing a CMOS transistor according to the second embodiment, after gate insulating film 35 is grown, a laser beam may be applied to the entire surface of gate insulating film 35 in order to reduce a fixed charge and an interfacial level that are present in the interface between polycrystalline silicon film 34 and gate insulating film 35. The energy density of the applied laser beam should be lower than the energy density of the laser beam applied as indicated by the arrows 33 in FIG. 9B for annealing amorphous silicon film 32. An RF device may be formed on a glass substrate of a display product such as a liquid crystal display unit, an EL display unit, or the like by the method of manufacturing the RF device according to the second embodiment. The RF device may be formed on the glass substrate of the display product before or after the process of manufacturing the display product. The RF device may be formed on either one of substrates on which a counter-electrode and a TFT are formed. Since the method of manufacturing the RF device according to the second embodiment can use a glass substrate, the method has a high affinity with the process of manufacturing the display product, and is free of process problems with respect to the process temperature and the chemical resistance, for example. For example, an RF device which integrally incorporates an authenticating function such as an ID authenticating function and an antenna may be combined with the display unit of a cellular phone, thereby increasing the functionality of the cellular phone. In such an application, the antenna should be made of a transparent conductor such as an ITO film or the like for preventing itself from obstructing images displayed by the display unit.

A first modification of the second embodiment of the present invention will be described below.

In the second embodiment described above, antenna 3 is formed by electrolytic plating as shown in FIGS. 10A through 10C. According to the first modification of the second embodiment, antenna 3 is formed by electroless plating as shown in FIGS. 11A and 11B. As shown in FIG. 11A, base film 61 which serves as a base for selectively growing an electrolessly plated film is formed on the entire surface of insulating substrate 1 by sputtering, for example. Then, base film 61 is patterned to the shape of antenna 3 by photolithography. Base film 61 is formed of aluminum or nickel, for example. Then, as shown in FIG. 11B, plated film 62 is formed on base film 61 by electroless plating. At this time, plated film 62 is selectively formed on base film 61. Plated film 61 is formed of nickel, copper, or gold, for example. Other details of the first modification of the second embodiment are identical to those of the second embodiment described above.

In the first modification of the second embodiment, plated film 62 is formed as a single-layer film. However, plated film 62 may be formed as a film having two or more layers. If plated film 62 is formed as a film having two or more layers including a first layer of nickel, then since nickel has an electric resistance that is 30 to 40 times higher than copper and gold, the second layer may be formed as a copper or gold layer for thereby reducing the electric resistance of plated film 62, i.e., antenna 3.

A second modification of the second embodiment of the present invention will be described below.

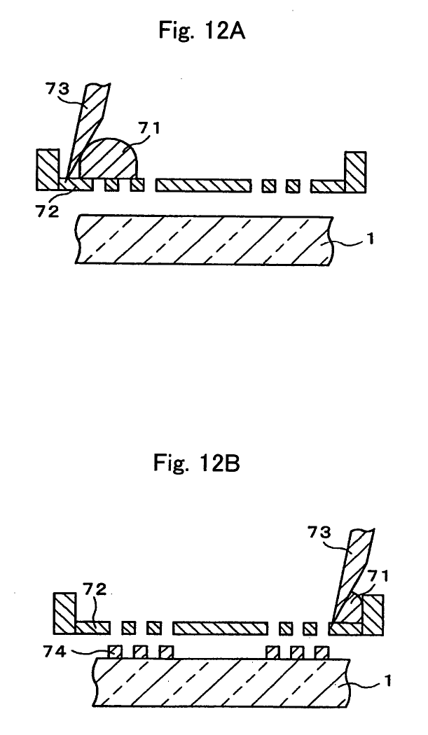

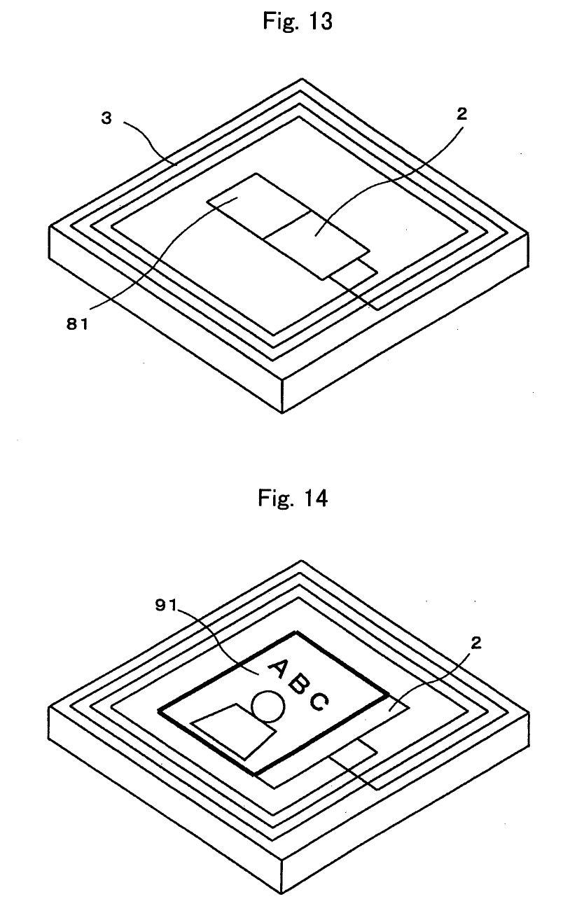

In the second embodiment described above, antenna 3 is formed by electrolytic plating as shown in FIGS. 10A through 10C. According to the second modification of the second embodiment, antenna 3 is formed by printing as shown in FIGS. 12A and 12B. As shown in FIG. 12A, a conductive paste 71 is placed on mask 72 having an opening patterned as antenna 3. Mask 72 comprises, for example, a screen mask comprising a mesh of fine fibers woven in a grid-like pattern and an emulsifying layer that has an opening in a desired pattern, the emulsifying layer being disposed on the mesh. Conductive paste 71 placed on mask 72 can be pushed through the opening of the emulsifying layer and the mesh to the reverse side of mask 72. Conductive paste 71 is a solder paste comprising a solvent with fine solder particles dispersed therein or a silver paste comprising a solvent with fine solder particles dispersed therein. From the standpoint of electric resistance, the silver paste is preferable. After the silver paste used as conductive paste 71 is baked to remove the solvent, the resistance of conductive paste 71 is essentially the same as the resistance of silver alone.

Then, as shown in FIG. 12B, squeezee 73 is pressed against conductive paste 71 to push conductive paste 71 through the opening of mask 72 onto insulating substrate 1, thereby applying printed pattern 74 of antenna 3 to insulating substrate 1. Thereafter, the entire assembly is heated to remove the solvent contained in printed pattern 74, thereby completing antenna 3. The assembly is heated in an oven at a temperature of 200° C. for example. Other details of the second modification of the second embodiment are identical to those of the second embodiment described above.

In the second modification of the second embodiment, a screen mask is used as mask 72. However, a metal mask comprising a metal plate with an opening defined in a desired pattern therein may be used as mask 72. Antenna 3 may also be formed by a process other than the electrolytic plating process, the electroless plating process, and the printing process described above. For example, antenna 3 maybe formed by coating a substrate with a conductive polymer with fine metal particles dispersed therein and patterning the conductive polymer to an antenna shape. Alternatively, an antenna pattern may directly be plotted on a substrate.

Multifunctional designs of the RF device according to the first embodiment of the present invention will be described below. RF devices according to third through eighth embodiments of the present invention to be described below are such multifunctional RF devices.

First, an RF device according to a third embodiment of the present invention will be described below.

In the first embodiment described above, only signal processing circuit 2 is disposed centrally on insulating substrate 1, as shown in FIG. 4. According to the third embodiment, as shown in FIG. 13, signal processing circuit 2 and memory circuit 81 are disposed adjacent to each other centrally on insulating substrate 1.

Memory circuit 81 comprises a ROM for storing information of an RF tag in advance and a DRAM or an SRAM for reading and writing information at the time of signal processing. The ROM, the DRAM, and the SRAM are fabricated by the process of manufacturing a CMOS according to the second embodiment described above. Other structural details of the third embodiment are identical to those of the first embodiment described above.

In the third embodiment, since memory circuit 81 is integrally disposed on the glass substrate on which signal processing circuit 2 and antenna 3 are formed, the manufacturing cost of the RF device having desired functions can be reduced, and the mounting cost thereof can also be reduced. If the functionality of an RF device is to be increased using a conventional RF tag as described above, then a device fabricated by another process has to be further assembled regardless of whether the RF tag is of the integral type or the separate type, resulting in an increase in the manufacturing cost and an increase in the assembly size. Since different devices are separately designed and produced, it is expected that design and production losses such as a performance mismatch between the devices will be increased. According to the third embodiment, however, as the memory circuit is formed integrally with the antenna on the insulating substrate, it is easy to design total impedance matching between the antenna and the circuit (device). Because the memory circuit is formed in a relatively wide area surrounded by the spiral coil antenna on the surface of the insulating substrate, the size of the multifunctional RF device is relatively small. Other advantages of the third embodiment are identical to those of the first embodiment described above.

In the third embodiment, memory circuit 81 comprises a ROM and a DRAM or an SRAM. However, memory circuit 81 may comprise a nonvolatile memory such as an EEPROM or an FeRAM. The EEPROM has a floating gate disposed in a gate insulating film of an ordinary CMOS structure. The EEPROM retains a charge or information even after the EEPROM is turned off. The FeRAM comprises a ferrodielectric capacitor connected to a transistor. When a write voltage is applied to the FeRAM, the ferrodielectric material is polarized. Even when the FeRAM is turned off, the ferrodielectric material remains polarized. The ferrodielectric capacitor is formed by a sol-gel process or an aerosol process. The process temperature of the sol-gel process or the aerosol process is in the range from 200 to 400° C., lower than the allowable temperature limit of the glass substrate as the insulating substrate.

An RF device according to a fourth embodiment of the present invention will be described below.

In the first embodiment described above, only signal processing circuit 2 is disposed centrally on insulating substrate 1, as shown in FIG. 4. According to the fourth embodiment, as shown in FIG. 14, signal processing circuit 2 and display unit 91 are disposed adjacent to each other centrally on insulating substrate 1. Display unit 91 comprises an organic EL (ElectroLuminescence) display unit, an inorganic EL display unit, or a liquid crystal display unit. Display unit 91 is fabricated according to a conventional fabrication process. Other structural details of the fourth embodiment are identical to those of the first embodiment described above.

In the fourth embodiment, the glass substrate is employed, and display unit 91 is integrally formed on the glass substrate on which signal processing circuit 2 and antenna 3 are formed. The RF device with the display function is relatively small in size. The RF device with display unit 91 is capable of displaying a result of information processing after it has exchanged information with a reader/writer. For example, a prepaid card with a communication function, which is constructed as the RF device, can display information of the balance or the like. The manufacturing cost of the RF device is low because it employs an inexpensive glass substrate, and the mounting cost thereof is also low. Other advantages of the fourth embodiment are identical to those of the third embodiment described above.

An RF device according to a fifth embodiment of the present invention will be described below.

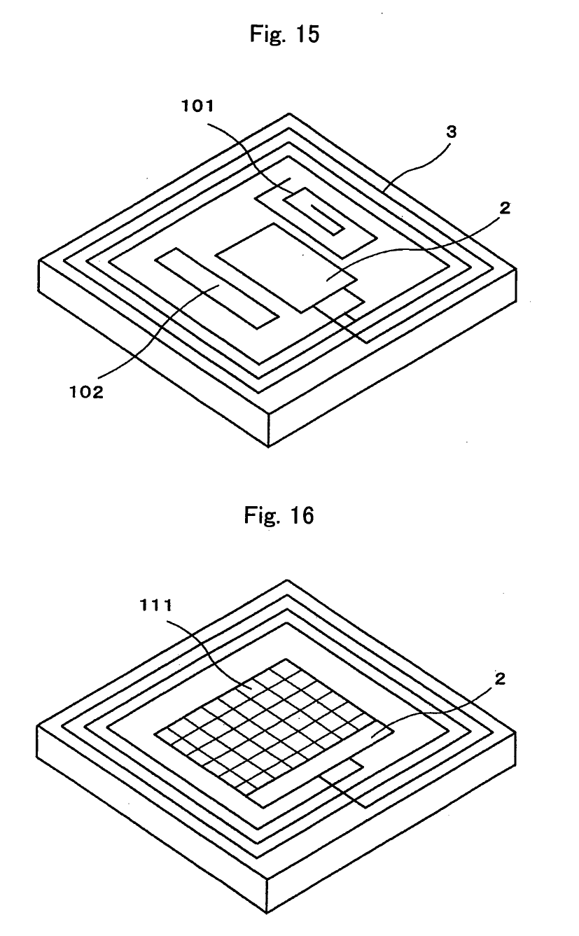

In the first embodiment described above, only signal processing circuit 2 is disposed centrally on insulating substrate 1, as shown in FIG. 4. According to the fifth embodiment, as shown in FIG. 15, the RF device has antennas 101, 102 disposed adjacent to signal processing circuit 2 that is disposed centrally on insulating substrate 1. Antennas 101, 102 have their lengths, sizes, etc. adjusted depending on frequencies to be handled. Antennas 101, 102 may be booster antennas which have a higher sensitivity for radio waves having a particular frequency. Antennas 101, 102 are not connected to signal processing circuit 2 by interconnection patterns. Other structural details of the fifth embodiment are identical to those of the first embodiment described above.

In the fifth embodiment, antennas 101, 102 are electrically connected to antenna 3 by a capacitive coupling or an electromagnetic inductive coupling for exchanging signals with signal processing circuit 2. Since signal processing circuit 2 and antennas 3, 101, 102 are integrally formed on the insulating substrate which comprises an inexpensive glass substrate, the antennas can be designed with increased freedom without being limited by the area of the substrate, so that the RF device with higher functionality can be realized.

At present, RF tags are subject to various specifications including different frequency bands, e.g., a low frequency band near 125 kHz, a 13.56 MHz band, a 900 MHz band, and a 2.54 GHz band. Main frequency bands for RF tags differ from country to country. Since different antennas are used for different frequency bands, it is difficult for one RF tag to be compatible with a plurality of frequency bands. This poses a problem when RF tags are used in material distributions between many countries. According to the fifth embodiment, however, the plural antennas on the RF device makes the RF device compatible with a plurality of frequency bands, thereby solving the above problem. Other advantages of the fifth embodiment are identical to those of the third embodiment described above.

An RF device according to a sixth embodiment of the present invention will be described below.

In the first embodiment described above, only signal processing circuit 2 is disposed centrally on insulating substrate 1, as shown in FIG. 4. According to the sixth embodiment, as shown in FIG. 16, signal processing circuit 2 and power supply device 111 are disposed centrally on insulating substrate 1. Power supply device 111 comprises a solar cell, for example. The solar cell has a substrate comprising a P-type silicon layer and an N-type silicon layer. When light is applied to the substrate, holes having a positive charge tend to move to the P-type silicon layer and electrons having a negative charge tend to move to the N-type silicon layer. The solar cell is fabricated by the method of manufacturing a CMOS according to the second embodiment, for example. Other structural details of the sixth embodiment are identical to those of the first embodiment described above.

As described above, general RF devices produce electromotive forces from radio waves transmitted from a reader/writer and operate based on the produced electromotive forces. However, since the radio waves transmitted from the reader/writer are very weak, it is difficult for the RF devices have an increased communication range. As the RF devices function only when the radio waves transmitted from the reader/writer reach them, the RF devices are unable to actively send radio waves when the reader/writer is turned off. According to the sixth embodiment, since the signal processing circuit and the power supply device are integrally disposed on the insulating substrate, the operating voltage of the RF device is high, can output radio waves of high intensity, and can have an increased communication range. As the power supply voltage of the RF device does not depend on the received radio waves, the RF device is able to actively send radio waves even when the RF device is not receiving radio waves. The RF device with the power supply device can meet requirements for increased electric energy required by expanded functionality. Other advantages of the sixth embodiment are identical to those of the third embodiment described above.

In the sixth embodiment, the power supply device comprises a solar cell. However, the power supply device may comprise any sheet-like cell such as a secondary cell, e.g., a lithium-ion secondary cell, or a primary cell. The lithium-ion cell comprises a three-layer laminated assembly having an insulative porous separator sandwiched between two sheet-like electrodes. The three-layer laminated assembly is immersed in an electrolytic solution and sandwiched between glass substrates that are sealingly encased. The lithium-ion cell is charged in a contactless manner by converting received radio waves into electromotive forces. This charging process allows a stack of RF tags to be charged altogether at the same time.

An RF device according to a seventh embodiment of the present invention will be described below.

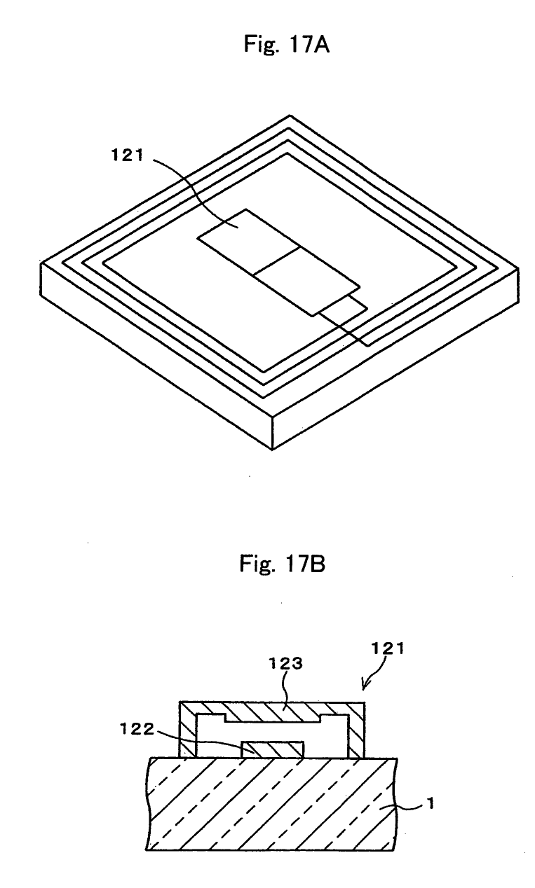

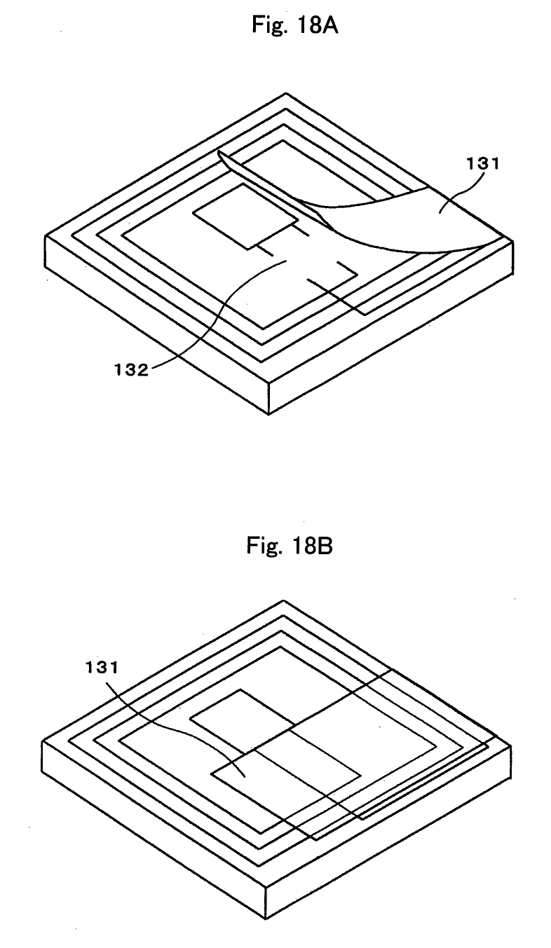

In the first embodiment described above, only signal processing circuit 2 is disposed centrally on insulating substrate 1, as shown in FIG. 4. According to the seventh embodiment, as shown in FIGS. 17A and 17B, signal processing circuit 2 and sensor circuit 121 are disposed centrally on insulating substrate 1. As shown in FIG. 17B, sensor circuit 121 comprises electrode 122 disposed on insulating substrate 1 and hollow body 123 disposed over electrode 122. Hollow body 123 comprises a pair of upstanding side plates mounted on insulating substrate 1 and an upper plate having opposite ends joined to respective upper ends of the upstanding side plates. Electrode 122 is disposed between the upstanding side plates. Electrode 122 is spaced a distance G from the upper plate of hollow body 123. Hollow body 123 comprises a thin silicon film or a thin metal film. Sensor circuit 121 is fabricated by the MEMS (Micro-Electro-Mechanical System) technology, for example. Other structural details of the seventh embodiment are identical to those of the first embodiment described above.

Operation of the RF device according to the seventh embodiment will be described below. When hollow body 123 of sensor circuit 121 flexes under downward pressure or acceleration, the distance G between the upper plate of hollow body 123 and electrode 122 changes. The change in the distance G is detected by measuring the electrostatic capacitance of a capacitor which is made up of the upper plate of hollow body 123 and electrode 122. When the change in the distance G is detected, the downward pressure or acceleration applied to the upper plate of hollow body 123 is also detected.

According to the second embodiment, as described above, since sensor circuit 121, signal processing circuit 2, and antenna 3 are integrally mounted on insulating substrate 1, information detected by sensor circuit 121 can be transmitted out of the RF device by radio waves. For example, sensor circuit 121 may comprise an air pressure sensor mounted on an automobile tire, and information detected as representing a tire air pressure by sensor circuit 121 may be transmitted from the RF device to a receiver in an automobile cabin where the information can be managed. According to the second embodiment, since sensor circuit 121, signal processing circuit 2, and antenna 3 are integrally mounted on insulating substrate 1, they are highly failure-resistant in harsh environments on automobiles. Other advantages of the seventh embodiment are identical to those of the third embodiment described above.

In the seventh embodiment, a pressure sensor has been described as sensor circuit 121. However, sensor circuit 121 may comprise a fingerprint sensor, an environment sensor such as a temperature sensor, a humidity sensor, or the like, a gas sensor, or an odor sensor. The pressure sensor may also be used as an acceleration sensor. The fingerprint sensor may be an optical sensor wherein an LED (Light-Emitting Diode) or the like applies light to a fingertip and light reflected by the fingertip is detected by a CCD (Charge-Coupled Device) or the like to determine the fingerprint based on changes in the detected light, or a pressure-sensitive sensor wherein the fingerprint is determined based on changes in the electrostatic capacitance between the fingertip and the sensor. The optical fingerprint sensor can be fabricated by the method of fabricating a CMOS according to the second embodiment, as a matrix of transistors and photodiodes formed on a glass substrate. The pressure-sensitive fingerprint sensor may be similar to the optical fingerprint sensor except that electrostatic capacitance detecting electrodes are formed instead of the photodiodes. The sensor circuit may be replaced with a mechanical input/output device such as a dip switch, a microphone, a speaker, a touch panel, or the like. The microphone may comprise a hollow thin film that can be vibrated under sound pressure applied thereto.

An RF device according to an eighth embodiment of the present invention will be described below.

In the first embodiment described above, antenna 3 and signal processing circuit 2 are electrically connected to each other on insulating substrate 1, as shown in FIG. 4. According to the eighth embodiment, as shown in FIGS. 18A and 18B, the RF device has isolated area 132 in which an interconnection pattern from antenna 3 to signal processing circuit 2 is partly removed, so that antenna 3 and signal processing circuit 2 are normally electrically disconnected from each other. The RF device also has removable conductive tape 131 which, when placed on insulating substrate 1, electrically connects antenna 3 and signal processing circuit 2 to each other. When removable conductive tape 131 is removed or spaced from insulating substrate 1, antenna 3 and signal processing circuit 2 are electrically disconnected from each other. When antenna 3 and signal processing circuit 2 are electrically disconnected from each other, the RF device is prevented from sending information to and receiving information from an external circuit, and is also prevented from erasing information from the RF device. The RF device can also have its tag function selectively tuned on and off by taking removable conductive tape 131 into and out of contact with insulating substrate 1. Other structural details and advantages of the eighth embodiment are identical to those of the first embodiment described above.

An RF device according to a ninth embodiment of the present invention will be described below.

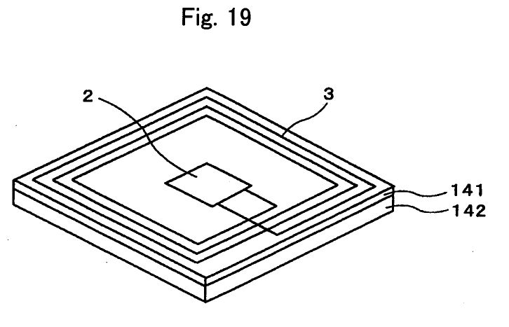

The RF device according to the ninth embodiment is a lower-profile version of the RF device according to the first embodiment. According to the first embodiment, antenna 3 and signal processing circuit 2 are disposed on single insulating substrate 1. According to the ninth embodiment, as shown in FIG. 19, an insulating substrate comprises a stacked assembly of glass substrate 141 and flexible substrate 142. Glass substrate 141 comprises a substrate made of non-alkali glass borosilicate containing boron oxide and alumina. Glass substrate 141 has a thickness of 200 μm or less, which makes the RF device flexible. If the thickness of glass substrate 141 exceeds 200 μm, then the EF device is not rendered flexible. If the thickness of glass substrate 141 is 0 μm, i.e., if the RF device has no glass substrate 141, then signal processing circuit 2 and antenna 3 have their characteristics and reliability lost.

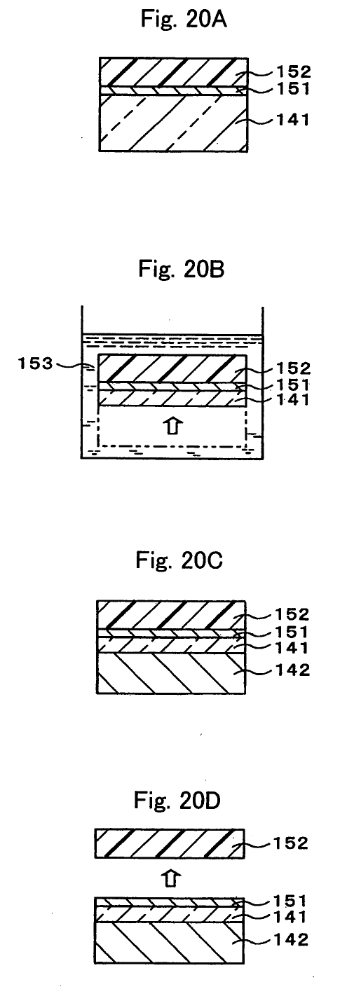

A method of manufacturing the RF device shown in FIG. 19 will be described below with reference to FIGS. 20A through 20D. The thickness of glass substrate 141 should preferably be reduced by etching after signal processing circuit 2 and antenna 3 have been formed on glass substrate 141. As shown in FIG. 20A, glass substrate 141 is prepared. At this time, glass substrate 141 has a thickness of 0.7 mm, for example. Then, circuit layer 151 including an antenna (not shown) and a signal processing circuit (not shown) is formed on glass substrate 141 by the process described above in the first embodiment. Then, protective film 152 is bonded by an adhesive (not shown) in covering relation to circuit layer 151. Protective film 152 is made of polyethylene, for example. However, protective film 152 may be made of any of various materials that are highly resistant to hydrofluoric acid such as polypropylene, polycarbonate, PET, or PES (PolyEtherSulfone). Protective film 152 should preferably have a thickness of 200 μm or less. If the thickness of protective film 152 exceeds 200 μm, then it cannot easily be peeled off.

Then, as shown in FIG. 20B, the stacked assembly of glass substrate 141, circuit layer 151, and protective film 152 is immersed in etching solution 153 for dissolving glass substrate 141. Etching solution 153 comprises a mixture of hydrofluoric acid and hydrochloric acid. The addition of hydrochloric acid is effective in efficiently etching away boron oxide and alumina that are contained in non-alkali borosilicate glass that glass substrate 141 is made of. The reverse side of glass substrate 141 which is remote from circuit layer 151 is thus etched away to reduce the thickness of glass substrate 141. The mixture of hydrofluoric acid and hydrochloric acid has an etching rate of 5 μm per minute with respect to non-alkali borosilicate glass. Therefore, when glass substrate 141 having a thickness of 0.7 mm is etched for 130 minutes, the thickness of glass substrate 141 is reduced to 50 μm. The etching rate can be increased if the temperature of etching solution 153 is increased. However, the temperature of etching solution 153 should preferably be 70° C. or less because the remaining thickness of glass substrate 141 cannot be controlled for good reproducibility if the temperature of etching solution 153 exceeds 70° C.

Then, as shown in FIG. 20C, flexible film 142 is applied in covering relation to the etched surface of glass substrate 141. Flexible film 142 comprises a PET film, for example, and has a thickness in the range from 10 μm to 2 mm, for example. If the thickness of flexible film 142 is smaller than 10 μm, then flexible film 142 is weak and liable to break. If the thickness of flexible film 142 exceeds 2 mm, then flexible film 142 is no longer flexible. Thereafter, as shown in FIG. 20D, protective film 152 is mechanically peeled off. The process time required to peel off protective film 152 is about several minutes, for example. Other structural details and manufacturing process details of the ninth embodiment are identical to those of the first and second embodiments.

In the ninth embodiment, glass substrate 141 used as the insulating substrate is thinned down and applied to flexible film 142, making the RF device flexible. Therefore, when the RF device is applied to flexible articles such as clothes or paper products or curved surfaces such as bottle surfaces, the RF device is less vulnerable to damage due to bending stresses. Other advantages of the ninth embodiment are identical to those of the first embodiment.

Except that the glass substrate and the flexible film are stacked together, the insulating substrate of the RF device according to the ninth embodiment has structural and operational details and advantages which are identical to those of the first embodiment. However, the insulating substrate of the RF device according to the ninth embodiment may have structural and operational details and advantages which are identical to those of the third through eighth embodiments.

Protective film 152 and circuit layer 151 may be bonded to each other by a thermoplastic adhesive. If protective film 152 and circuit layer 151 are bonded to each other by a thermoplastic adhesive, then protective film 152 can easily be peeled off in a short period of time by heating the thermoplastic adhesive. For example, if an adhesive which becomes solid at a temperature of 80° C. or lower and becomes liquid at a temperature higher than 80° C., then when the atmospheric temperature in the protective film peeling process is set to 100° C., the adhesive is liquefied, allowing the protective film to be peeled off easily within a short period of time. Protective film 152 may be made of a resin material which can be applied to circuit layer 151 and then hardened into a protective film.

An RF apparatus according to a tenth embodiment of the present invention will be described below.

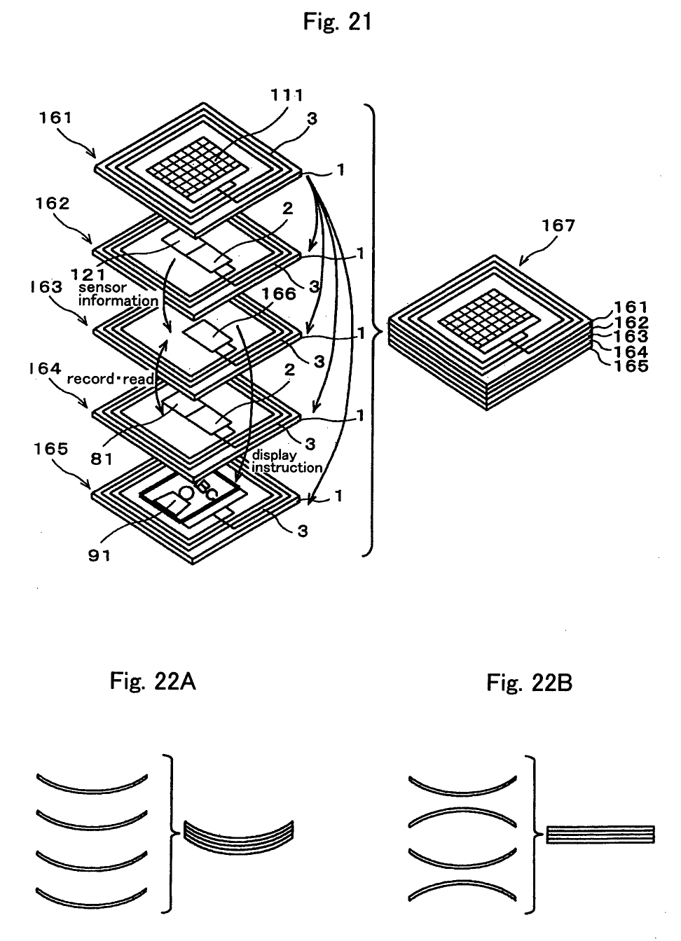

As shown in FIG. 21, RF apparatus 167 according to the tenth embodiment comprises a plurality of laminated RF devices 165, 164, 163, 162, 162. RF device 165 comprises the RF device according to the fourth embodiment, and has signal processing circuit 2, antenna 3, and display unit 91 on insulating substrate 1. RF device 164 comprises the RF device according to the third embodiment, and has signal processing circuit 2, antenna 3, and memory circuit 81 on insulating substrate 1. Memory circuit 81 comprises a DRAM or SRAM which can retain data only when it is supplied with electric energy, or a nonvolatile EEPROM or FeRAM which keeps on retaining data even when it is turned off.

RF device 163 has a CPU (Central Processing Unit) 166, in place of signal processing circuit 2 according to the first embodiment, for instructing memory circuit 81 to record and read data, and also instructing display unit 91 to display data. Other structural details of RF device 163 are identical to those of the RF device according to the first embodiment. RF device 162 comprises the RF device according to the seventh embodiment, and has signal processing circuit 2, antenna 3, and sensor circuit 121 on insulating substrate 1. Sensor circuit 121 comprises a pressure sensor, a temperature sensor, a humidity sensor, or the like. RF device 161 comprises the RF device according to the sixth embodiment, and has signal processing circuit 2, antenna 3, and power supply device 111 on insulating substrate 1. Power supply device 111 comprises a solar cell, for example. RF apparatus 167 has a thickness of 1 mm, for example. Each of RF devices 161 through 165 may comprise a flexible RF device according to the ninth embodiment, for example. RF devices 161 through 165 have respective thicknesses adjusted such that the thickness of RF apparatus 167 is 1 mm. For example, RF devices 161 through 165 have respective thicknesses of 200 μm, or one of RF devices 161 through 165 has an unetched thickness of 0.7 mm and each of the other four RF devices has an etched thickness of 50 μm, such that the thickness of RF apparatus 167 is about 1 mm.

A method of manufacturing RF apparatus 167 according to the tenth embodiment will be described below.

The method of manufacturing RF apparatus 167 comprises the steps of fabricating RF devices 161 through 165 and the step of laminating RF devices 161 through 165 to securing them together. In manufacturing RF apparatus 167, care should be taken not to develop warpage in the RF apparatus after the RF devices are bonded together. As shown in FIGS. 22A and 22B, each of the RF devices to be laminated often has a certain degree of warpage. If the RF devices that are warped in the same direction are laminated as shown in FIG. 22A, then the RF apparatus is also warped in the same direction as the RF devices are warped. Specifically, if the RF devices are stacked in downwardly convex orientations and bonded together, then the RF apparatus is also warped in the downwardly convex orientation. According to the tenth embodiment, as shown in FIG. 22B, an uppermost RF device is oriented so as to be downwardly convex, and an RF device disposed beneath the uppermost RF device is oriented so as to be upwardly convex. In this manner, RF devices that are oriented so as to be downwardly and upwardly convex, respectively, are stacked alternately to have their warpage cancel each other. As a result, the RF apparatus manufactured by stacking the RF devices is free of warpage.

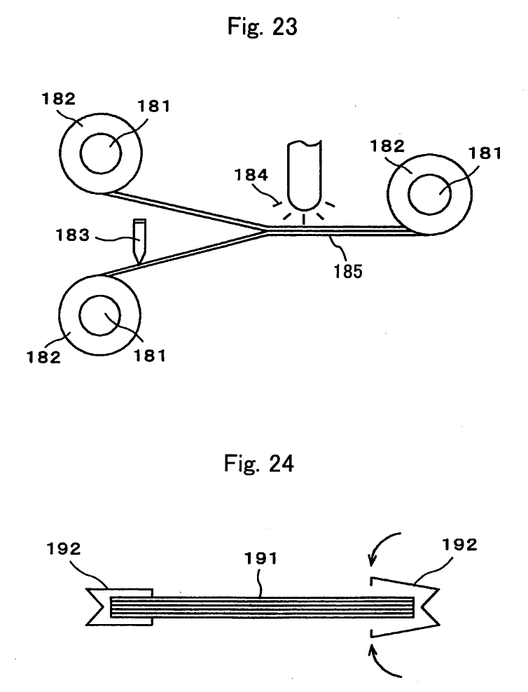

The RF devices are fastened together by an adhesive which is set at room temperature, e.g., a UV-curable adhesive which is curable by absorbing ultraviolet rays. For example, as shown in FIG. 23, flexible RF devices according to the ninth embodiment are laminated according to a roll-to-roll production process. Specifically, two sheets 182 each supporting a plurality of RF devices formed thereon are wound as rolls on respective cylindrical bobbins 181. Sheets 182 are unreeled from respective bobbins 181, and placed against each other with UV-curable adhesive 183 applied therebetween. Then, ultraviolet radiation 184 is applied to cure UV-curable adhesive 183 to bond two sheets 181 into laminated body 185, which is wound into a roll on cylindrical bobbin 181. In this manner, a plurality of RF devices are laminated and secured together, producing an RF apparatus.

Operation of RF apparatus 167 according to the tenth embodiment will be described below.

In FIG. 21, the electric energy stored by power supply device 111 of RF device 161 is supplied as radio waves to RF devices 162 through 165, energizing the circuits of RF devices 162 through 165. RF devices 162 through 165 may also generate electromotive forces from radio waves transmitted from a reader/writer, and may use both the electromotive forces thus generated and the electric energy supplied from RF device 161. In RF device 162, sensor circuit 121 operates to detect necessary information. The information detected by sensor circuit 121 is sent from antenna 3 of RF device 162 to RF device 163. In RF device 163, CPU 166 processes the information transmitted from RF device 162 through antenna 3.

At this time, memory circuit 81 of RF device 164 is instructed to read and write information, if necessary. Memory circuit 81 stores ID information of the RF apparatus or information previously detected by sensor circuit 121. Memory circuit 81 may comprise a nonvolatile memory such as an EEPROM or an FeRAM, so that information that is written in memory circuit 81 may be retained even after it is turned off. Alternatively, memory circuit 81 may comprise a DRAM or an SRAM, so that it can retain information only while it is being supplied with the electric energy from power supply device 111 of RF device 161. Processed results are transmitted through antenna 3 to display unit 91 of RF device 165 and an external reader/writer (not shown). Display unit 91 displays data or an alarm in a visually recognizable fashion. The reader/writer stores the transmitted information in a computer for management.

As described above, the RF apparatus according to the tenth embodiment is constructed of a laminated assembly of RF devices having various functions, and allows signals to be exchanged between the RF devices as radio waves through the antennas. The RF apparatus can thus have higher functionality for higher added values. According to the tenth embodiment, since electric energy and signals are sent and received by way of radio waves between the RF devices of the RF apparatus, it is not necessary to provide junctions of metal or ACF between the RF devices. Therefore, the mount cost of the RF apparatus is relatively low, and the RF apparatus is free of junction failures due to thermal stresses or bending stresses which would otherwise be detrimental to junctions. RF device 161 with the solar cell mounted thereon is positioned in the uppermost layer of RF apparatus 167, as shown in FIG. 21. Consequently, the solar cell is exposed to much solar radiation for higher electric generating efficiency. If an RF apparatus incorporates an RF device with a solar cell, therefore, the RF device with the solar cell should preferably be placed in the uppermost layer of the RF apparatus.

By laminating flexible RF devices according to the roll-to-roll process, the RF apparatus can achieve higher functionality efficiently in a relatively small number of man-hours. It is difficult to keep the RF devices in strict alignment with each other in the roll-to-roll process. However, since electric energy and signals are exchanged by way of radio waves between the RF devices according to the tenth embodiment, there is no need for direct contact between the RF devices, and hence the RF devices do not need to be strictly aligned with each other.

Furthermore, because the RF devices are bonded to each other by an adhesive such as an UV-curable adhesive that works at room temperature, it is not necessary to heat the adhesive to set. Accordingly, the RF devices are not deformed by heat, and are not warped as they do not need to be cooled after they are bonded. Since the glass substrate is used as the substrate of each of the RF devices, the ultraviolet radiation can penetrate the RF apparatus deep enough to reach its center.

In the tenth embodiment, an anaerobic adhesive may be used instead of the UV-curable adhesive to bond RF devices to each other. The anaerobic adhesive does not cause RF devices to warp as with the UV-curable adhesive though it takes some time to set the anaerobic adhesive and hence the anaerobic adhesive is not efficient to use. Alternatively, a sticky medium such as a double-sided tape or the like may be used. The sticky medium does not cause RF devices to warp as with the UV-curable adhesive and the anaerobic adhesive. Though the sticky medium such as a double-sided tape or the like makes it difficult to align the RF devices with each other, since electric energy and signals are exchanged by way of radio waves between the RF devices according to the present embodiment, the RF devices do not need to be strictly aligned with each other, and hence use of the sticky medium is sufficiently practical.

RF devices may further be bonded to each other mechanically by clips, screws, crimping, or the like. FIG. 24 shows a process of mechanically securing RF devices with clips. As shown in FIG. 24, laminated body 191 has its end clamped and secured by clips 192. The RF devices thus secured together can easily be removed, so that the RF apparatus can have its functions customized or any malfunctioning layers to be replaced.

Further alternatively, a plurality of RF devices may be bonded together by a tape whose adhesive force can be removed by exposure to ultraviolet radiation or heat. The RF devices thus bonded together can easily be removed, so that the RF apparatus can have its functions customized or any malfunctioning layers to be replaced.

According to the tenth embodiment, communications between the layers are performed by radio waves. However, some of the layers may be connected by metal or ACF so that the RF apparatus is of a hybrid structure wherein both radio or wireless communications and wired communications are performed. In the tenth embodiment, radio signals between the layers may possibly suffer interference. However, such signal interference may be suppressed by allocating appropriate frequencies or modulating processes to communications between the layers. Signals between the layers may be distinguished on a software basis by adding identification signals to the leading ends of signals that are transmitted from the respective layers. In the tenth embodiment, RF devices that are warped so as to be upwardly and downwardly convex, respectively, are stacked alternately. However, the present invention is not limited to such a stacking process. RF devices may be stacked in any fashion so as to minimize the warpage of the RF apparatus, and the number and order of stacked RF devices may be adjusted appropriately. Reinforcing plates may also be stacked in combination with RF devices for providing resistive forces against bending stresses developed in the RF apparatus. If each of the RF devices has a thickness of several tens μm, then any reactive forces of the RF devices are small even if they are warped. Therefore, the warpage of the RF devices can be corrected even if the reinforcing plates are relatively thin. Furthermore, spacers may be placed between RF devices. For example, dielectric members having a predetermined thickness may be placed between RF devices for adjusting the sensitivity of the antennas. In the tenth embodiment, single RF devices are stacked to produce a single RF apparatus. However, a plurality of sheet-like insulating substrates each supporting a matrix of RF devices thereon may be stacked to produce a single RF apparatus.

A method of inspecting an RF device according to an eleventh embodiment of the present invention will be described below.

According to the eleventh embodiment, when the RF devices or the RF apparatus according to the above embodiments is manufactured, they are inspected to see if they are acceptable or not.

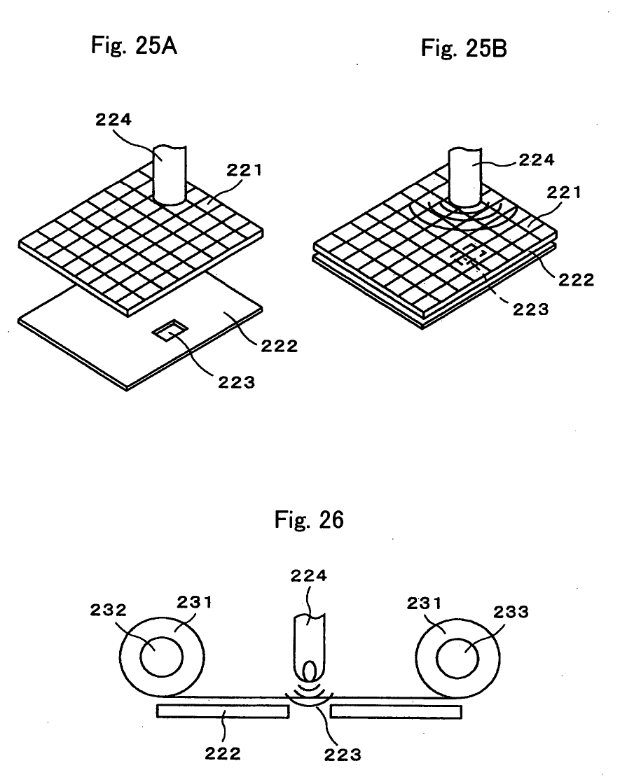

As shown in FIG. 25A, a matrix of RF devices are formed on glass substrate 221. The RF devices may be manufactured by the method according to the second embodiment. The RF devices formed on glass substrate 221 are to be inspected. Selector 222 in the form of a conductive plate having opening 223 that is shaped and sized complementarily to one RF device is prepared. Then, glass substrate 221 is superposed on selector 222 to align opening 223 with an RF device to be inspected among the RF devices on glass substrate 221. Opening 223 is now positioned behind the RF device to be inspected among the RF devices on glass substrate 221, and the conductive plate is positioned behind the other RF devices. Then, as shown in FIG. 25B, head 224 of a reader/writer is brought closely to the RF device to be inspected, and applies an inspection signal by way of radio waves.

In radio communications, when a conductor such as metal approaches an antenna, radio waves are blocked by the conductor, and substantially no communications can be performed. According to the eleventh embodiment, when selector 222 is brought closely to glass substrate 221, all the RF devices except the RF device to be inspected fail to communicate. Therefore, no interference occurs between the RF device to be inspected and the other RF devices, and only the RF device to be inspected can be inspected with high accuracy. By successively moving opening 223 with respect to glass substrate 221, the RF devices on glass substrate 221 are successively checked. The method of inspecting an RF device according to the eleventh embodiment can also be used to communicate with a certain RF device for writing initial data therein.

An RF device may be inspected by radio waves after it has been formed on an insulating substrate. Initial data such as ID data to be given in advance may be input to an RF device by radio waves. A plurality of sets of antennas and signal processing circuits may be formed on a single insulating substrate of glass and then the insulating substrate may be cut into a plurality of RF devices. In such a manufacturing process, if the above inspecting method is performed or the initial data are input after the insulating substrate is cut into RF devices, then the efficiency with which to handle RF devices is extremely low. According to the present embodiment, however, selector 222 is used to apply radio waves selectively to one RF device only. Therefore, RF devices that are still placed on a sheet or a roll may be inspected or supplied with initial data before the insulating substrate is cut to separate the RF devices. In this manner, the RF devices can be handled easily with increased efficiency.

A modification of the method of inspecting an RF device according to the eleventh embodiment will be described below.

In the eleventh embodiment, as shown in FIG. 25A, RF devices disposed on a plate-shaped glass substrate are to be inspected. According to the modification of the eleventh embodiment, as shown in FIG. 26, flexible RF devices manufactured by a roll-to-roll process are to be inspected. In FIG. 26, a sheet supporting thereon RF devices 231 to be inspected is wound into a roll on cylindrical bobbin 232. The sheet is unreeled and placed over selector 222 for inspecting RF devices 231, and then wound into a roll on cylindrical bobbin 233 after RF devices 231 are inspected. When bobbins 232, 233 are rotated, the sheet is unreeled and wound to position a plurality of RF devices successively between opening 223 in selector 222 and head 224 for successively inspecting the RF devices. Other structural details and advantages of the modification of the eleventh embodiment are identical to those of the eleventh embodiment.

In the eleventh embodiment and its modification, one RF device is inspected at a time. However, a plurality of RF devices may simultaneously be inspected. When a plurality of RF devices are simultaneously inspected, they are spaced from each other to avoid interference therebetween. Selector 222 has a plurality of openings 223 positioned for alignment with the respective RF devices to be inspected. Openings 223 are then positioned in alignment with the respective RF devices to inspect the RF devices.

While preferred embodiments of the present invention have been described using specific terms, such description is for illustrative purposes only, and it is to be understood that changes and variations may be made without departing from the spirit or scope of the following claims.

What is claimed is:

1. An RF device comprising:
an insulating substrate;
a signal processing circuit disposed on said insulating substrate; and
an antenna for radio communications integrally formed with said signal processing circuit on said insulating substrate, said antenna being connected to said signal processing circuit.

2. An RF device according to claim 1, wherein said insulating substrate comprises a glass substrate.

3. An RF device according to claim 1, wherein said insulating substrate comprises a plastic substrate.

4. An RF device according to claim 1, further comprising:
a memory integrally formed with said signal processing circuit and said antenna on said insulating substrate.

5. An RF device according to claim 4, wherein said memory comprises a memory selected from a ROM, an EEPROM, an FeRAM, a DRAM, and an SRAM.

6. An RF device according to claim 1, further comprising:
a display unit integrally formed with said signal processing circuit and said antenna on said insulating substrate.

7. An RF device according to claim 6, wherein said display unit comprises a display unit selected from a liquid crystal display unit, an organic EL display unit, and an inorganic EL display unit.

8. An RF device according to claim 1, further comprising:
a power supply device integrally formed with said signal processing circuit and said antenna on said insulating substrate.

9. An RF device according to claim 8, wherein said power supply unit comprises a solar cell or a lithium-ion secondary cell.

10. An RF device according to claim 1, further comprising:
a sensor integrally formed with said signal processing circuit and said antenna on said insulating substrate.

11. An RF device according to claim 10, wherein said sensor comprises a sensor selected from a pressure sensor, an acceleration sensor, a temperature sensor, a humidity sensor, an odor sensor, and a fingerprint sensor.

12. An RF device according to claim 1, further comprising:
a mechanical input/output device disposed on said insulating substrate.

13. An RF device according to claim 12, wherein said mechanical input/output device comprises a device selected from a dip switch, a touch panel, a microphone, and a speaker.

14. An RF device according to claim 1, further comprising:
another antenna disposed on said insulating substrate.

15. An RF device according to claim 14, wherein different communication frequencies are assigned respectively to said first-mentioned antenna and said other antenna.

16. An RF device according to claim 14, wherein said other antenna comprises a booster antenna.

17. An RF device according to claim 1, wherein said insulating substrate has a thickness of at most 200 μm.

18. An RF device according to claim 17, further comprising:
a protective film disposed in covering relation to said signal processing circuit and said antenna.

19. An RF device according to claim 1, wherein said antenna comprises a coil antenna, said antenna has an area of at least 1 cm² surrounded by an outermost pattern edge thereof.

20. An RF device according to claim 1, wherein said antenna comprises a dipole antenna, said antenna having a length of at least 3 cm.

21. An RF device according to claim 1, wherein said insulating substrate comprises a substrate of an display unit.

22. An RF apparatus comprising:
a plurality of RF devices according to claim 1, said RF devices being stacked together.

23. An RF apparatus according claim 22, wherein radio communications are performed between at least two of said RF devices.

24. An RF apparatus according claim 23, wherein radio communications are performed between at least three of said RF devices, and different frequencies are assigned to radio communications between a pair of said RF devices and radio communications between another pair of said RF devices.

25. An RF apparatus according claim 23, wherein radio communications are performed between at least three of said RF devices, and different modulating processes are assigned to radio communications between a pair of said RF devices and radio communications between another pair of said RF devices.

26. An RF apparatus according claim 22, further comprising:
reinforcing members disposed between said RF devices or outside of the RF devices disposed in outermost layers.

27. An RF apparatus according claim 22, wherein one of the RF devices disposed in outermost layers has a solar cell.

28. A method of manufacturing an RF device, comprising the steps of:
forming a signal processing circuit on an insulating substrate according to a TFT fabrication process; and
forming an antenna connected to said signal processing circuit on said insulating substrate.

29. A method according to claim 28, wherein said step of forming an antenna is performed continuously after said step of forming a signal processing circuit.

30. A method according to claim 28, further comprising the step of:
forming a memory on said insulating substrate.

31. A method according to claim 28, further comprising the step of:
forming a display unit on said insulating substrate.

32. A method according to claim 28, further comprising the step of:
forming a power supply device on said insulating substrate.

33. A method according to claim 28, further comprising the step of:
forming a sensor on said insulating substrate.

34. A method according to claim 28, further comprising the step of:
forming a mechanical input/output device on said insulating substrate.

35. A method according to claim 28, wherein said step of forming an antenna comprises the step of forming an interconnection according to a plating process.

36. A method according to claim 28, wherein said step of forming an antenna comprises the step of forming an interconnection by printing a conductive paste.

37. A method according to claim 28, further comprising the step of:
etching a surface of said insulating substrate remote from said signal processing circuit and said antenna to thin said insulating substrate.

38. A method according to claim 28, wherein said step of forming a signal processing circuit comprises the step of forming a plurality of signal processing circuits on said insulating substrate as a single insulating substrate, and said step of forming an antenna comprises the step of forming a plurality of antennas in association with said signal processing circuits, respectively, on said single insulating substrate;
said method further comprising the step of:
cutting said insulating substrate into a plurality of pieces having respective sets of said signal processing circuits and said antennas.

39. A method according to claim 38, further comprising the step of:
inspecting said RF device to check if the RF device is acceptable or not, between said step of forming an antenna and said step of cutting said insulating substrate.

40. A method according to claim 39, wherein said step of inspecting said RF device comprises the steps of:
positionally adjusting, with respect to said insulating substrate, a conductive plate made of a conductive material and having an opening for alignment with a single RF device or a plurality of spaced RF devices, to position said opening in alignment with said single RF device or said spaced RF devices; and
inspecting said single RF device or said spaced RF devices by applying an inspecting signal by way of radio waves to said single RF device or said spaced RF devices.

41. A method according to claim 40, wherein said step of inspecting said single RF device or said spaced RF devices comprises the steps of:
after said single RF device or said spaced RF devices have been inspected, moving said conductive plate and said insulating substrate relatively to each other to position said opening in alignment with another single RF device or another plurality of spaced RF devices; and
inspecting said other single RF device or other RF devices.

42. A method according to claim 41, wherein said insulating substrate comprises a sheet-like substrate, and said insulating substrate and said conductive plate are moved relatively to each other by delivering said insulating substrate from one roll to another roll.

43. A method according to claim 40, wherein said RF devices are successively inspected while said conductive plate and said insulating substrate are being moved relatively to each other.

44. A method according to claim 43, wherein said insulating substrate comprises a sheet-like substrate, and said insulating substrate and said conductive plate are moved relatively to each other by delivering said insulating substrate from one roll to another roll.

45. A method of manufacturing an RF apparatus, comprising the steps of:
fabricating an RF device by the method according to claim 28; and
stacking and securing together a plurality of said RF devices.

46. A method according to claim 45, wherein said step of securing said RF devices comprises the step of:
bonding said RF devices together with a room-temperature-curable adhesive.

47. A method according to claim 46, wherein said room-temperature-curable adhesive comprises an UV-curable adhesive or an anaerobic adhesive.

48. A method according to claim 45, wherein said step of securing said RF devices comprises the step of:
joining said RF devices together with a sticky medium.

49. A method according to claim 45, wherein said step of securing said RF devices comprises the step of:
fixing said RF devices removably together.

50. A method according to claim 49, wherein said RF devices are fixed together by clips.

51. A method according to claim 49, wherein said RF devices are fixed together by screws.

52. A method according to claim 49, wherein said RF devices are fixed together by a sticky medium having adhesive force removable by exposure to ultraviolet radiation.

53. A method according to claim 49, wherein said RF devices are fixed together by a sticky medium having adhesive force removable by exposure to heat.

54. A method according to claim 45, wherein said step of securing said RF devices comprises the steps of:
adjusting face and reverse sides of said RF devices to cancel out warpage of the RF devices; and
thereafter, stacking said RF devices.

55. A method according to claim 45, wherein said step of fabricating an RF device comprises the steps of:
forming said signal processing circuit and said antenna on said insulating substrate as a sheet-like insulating substrate; and
winding said sheet-like insulating substrate into a roll;
wherein said step of securing said RF devices comprises the steps of:
unreeling sheet-like insulating substrates from respective rolls; and
superposing said unreeled sheet-like insulating substrates and securing the superposed sheet-like insulating substrates to each other.

56. A method according to claim 55, wherein said step of securing said RF devices comprises the step of:
winding said secured sheet-like insulating substrates into another roll.

57. A method according to claim 45, wherein said step of fabricating an RF device comprises the steps of:
fabricating a plurality of sets of said signal processing circuits and said antennas on said insulating substrate; and
wherein said step of securing said RF devices comprises the step of:
cutting said insulating substrate into a plurality of pieces having said sets of said signal processing circuits and said antennas, respectively.

58. A method of inspecting an RF device, comprising the steps of:
positionally adjusting a conductive plate made of a conductive material and having an opening for alignment with a single RF device or a plurality of spaced RF devices, with respect to an RF device sheet having a plurality of RF devices each comprising a signal processing circuit and an antenna disposed on an insulating substrate, to position said opening in alignment with said single RF device or said spaced RF devices; and
inspecting said single RF device or said spaced RF devices by applying an inspecting signal by way of radio waves to said single RF device or said spaced RF devices.

59. A method according to claim 58, further comprising the steps of:
after said single RF device or said spaced RF devices have been inspected, moving said conductive plate and said RF device sheet relatively to each other to position said opening in alignment with another single RF device or another plurality of spaced RF devices; and
inspecting said other single RF device or other RF devices.

60. A method according to claim 59, wherein said RF device sheet and said conductive plate are moved relatively to each other by delivering said RF device sheet from one roll to another roll.

61. A method according to claim 58, wherein said RF devices are successively inspected while said conductive plate and said RF device sheet are being moved relatively to each other.

62. A method according to claim 61, wherein said RF device sheet and said conductive plate are moved relatively to each other by delivering said RF device sheet from one roll to another roll.

63. An apparatus for inspecting an RF device on an RF device sheet having a plurality of RF devices each comprising a signal processing circuit and an antenna disposed on an insulating substrate, comprising:
a conductive plate made of a conductive material and having an opening for alignment with a single RF device or a plurality of spaced RF devices, said opening being positionable in alignment with said single RF device or said RF devices to be inspected; and
a reader/writer for applying an inspecting signal by way of radio waves to said single RF device or said spaced RF devices.
